(19) United States
(12) Patent Application Publication
(10) Pub. No.: US 2005/0278439 A1
(43) Pub. Date: Dec. 15, 2005

(54) System and method for evaluating capacity of a heterogeneous media server configuration for supporting an expected workload

(76) Inventor: Ludmila Cherkasova, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/867,556

(22) Filed: Jun. 14, 2004

(51) Int. Cl. G06F 15/173

(52) U.S. Cl. 709/223

(57) ABSTRACT

According to at least one embodiment, a method comprises receiving, into a capacity planning system, workload information representing an expected workload of client accesses of streaming media files from a site. The capacity planning system evaluates whether a heterogeneous cluster having a plurality of different server configurations included therein is capable of supporting the expected workload in a desired manner.

### CROSS-REFERENCE TO RELATED APPLICATIONS

This application is related to the following co-pending and commonly assigned patent applications: 1) U.S. patent application Ser. No. 10/306,279 filed Nov. 27, 2002 entitled “SYSTEM AND METHOD FOR MEASURING THE CAPACITY OF A STREAMING MEDIA SERVER,” 2) U.S. patent application Ser. No. 10/601,956 filed Jun. 23, 2003 entitled “SYSTEM AND METHOD FOR MODELING THE MEMORY STATE OF A STREAMING MEDIA SERVER,” 3) U.S. patent application Ser. No. 10/601,992 filed Jun. 23, 2003 entitled “COST-AWARE ADMISSION CONTROL FOR STREAMING MEDIA SERVER,” 4) U.S. patent application Ser. No. 10/660,978 filed Sep. 12, 2003 entitled “SYSTEM AND METHOD FOR EVALUATING A CAPACITY OF A STREAMING MEDIA SERVER FOR SUPPORTING A WORKLOAD,” 5) U.S. patent application Ser. No. 10/738,273 filed Dec. 17, 2003 entitled “SYSTEM AND METHOD FOR DETERMINING HOW MANY SERVERS OF AT LEAST ONE SERVER CONFIGURATION TO BE INCLUDED AT A SERVICE PROVIDER'S SITE FOR SUPPORTING AN EXPECTED WORKLOAD,” and 6) U.S. patent application Ser. No. 10/801,793 filed Mar. 16, 2004 entitled “SYSTEM AND METHOD FOR DETERMINING A STREAMING MEDIA SERVER CONFIGURATION FOR SUPPORTING EXPECTED WORKLOAD IN COMPLIANCE WITH AT LEAST ONE SERVICE PARAMETER,” the disclosures of which are hereby incorporated herein by reference.

### FIELD OF THE INVENTION

The following description relates in general to evaluating a capacity of a streaming media server for supporting a workload, wherein the streaming media server is implemented as a cluster, and more particularly to evaluating capacity of a cluster of heterogeneous servers for supporting a workload of a streaming media site.

### DESCRIPTION OF RELATED ART

An abundance of information is available on client-server networks, such as the Internet, Intranets, the World Wide Web (the “web”), other Wide and Local Area Networks (WANs and LANs), wireless networks, and combinations thereof, as examples, and the amount of information available on such client-server networks is continuously increasing. Further, users are increasingly gaining access to client-server networks, such as the web, and commonly look to such client-server networks (as opposed to or in addition to other sources of information) for desired information. For example, a relatively large segment of the human population has access to the Internet via personal computers (PCs), and Internet access is now possible with many mobile devices, such as personal digital assistants (PDAs), mobile telephones (e.g., cellular telephones), etc.

An increasingly popular type of technology for providing information to clients is known as “streaming media.” In general, streaming media presents data (e.g., typically audio and/or video) to a client in a streaming or continuous fashion. That is, with streaming media a client is not required to receive all of the information to be presented before the presentation begins. Rather, presentation of information in a streaming media file may begin before all of the file is received by the client, and as the received portion of the file is being presented, further portions of the file continue to be received by the client for later presentation. Thus, streaming media involves media (e.g., typically audio and/or video) that is transmitted from a server (e.g., a media server) to a client and begins playing on the client before fully downloaded.

Media servers are typically implemented for providing streaming media to clients. A “cluster” is often used to implement a media server. In general, a cluster is a group of nodes (e.g., servers and/or other resources) that appear to a user as a single system. For instance, a plurality of servers may be implemented as a cluster to form a single media server for serving streaming media files to requesting clients. While a plurality of different servers are used for servicing the clients' requests, to each client the cluster appears to be a single media server (i.e., it appears to the clients that they are accessing a single media server). Such cluster computing may be implemented to provide high availability (e.g., through redundancy provided by the plurality of nodes), parallel processing, and/or load balancing. Various load balancing strategies may be used for a cluster, including as examples a round-robin strategy or a “locality-aware” strategy, e.g., Locality-Aware Request Distribution (“LARD”) strategy.

Various streaming media files may be provided concurrently by a media server to various different clients. That is, a plurality of clients may concurrently access streaming media files from the media server. Of course, limits exist as to how many concurrent streams a media server can support for a given client population. That is, limits exist as to the capacity of a media server, even a clustered media server, for supporting a given “workload” (i.e., a number of concurrent client accesses of streaming media from the media server). Streaming media service providers have traditionally had difficulty in evaluating whether a given media server configuration (e.g., a server implementation having a certain size of memory, certain disk configuration, certain number of nodes in a cluster, etc.) provides sufficient capacity for supporting the service providers' workload as desired. Thus, streaming media service providers have traditionally had difficulty in evaluating different media server configurations for capacity planning to, for example, determine the most cost-effective configuration that is capable of supporting the service providers' media service workload.

### BRIEF SUMMARY OF THE INVENTION

According to at least one embodiment, a method comprises receiving, into a capacity planning system, workload information representing an expected workload of client accesses of streaming media files from a site. The capacity planning system evaluates whether a heterogeneous cluster having a plurality of different server configurations included therein is capable of supporting the expected workload in a desired manner.

According to at least one embodiment, a method comprises receiving, into a capacity planning system, workload information representing an expected workload of client accesses of streaming media files from a site. The method further comprises the capacity planning system receiving identification of a plurality of different server configurations to consider in determining a media server solution that is capable of supporting the expected workload in a desired manner, and the capacity planning system determining at least one clustered media server solution that is capable of supporting the expected workload in the desired manner, wherein in determining the at least one clustered media server solution, the capacity planning system is operable to evaluate at least one heterogeneous cluster having a mix of the plurality of different server configurations.

According to at least one embodiment, a method comprises receiving, into a capacity planning system, workload information representing an expected workload of client accesses of streaming media files from a site. The method further comprises the capacity planning system determining at least one heterogeneous cluster to evaluate, and the capacity planning system evaluating whether the determined at least one heterogeneous cluster is capable of supporting the expected workload in a desired manner.

According to at least one embodiment, a method comprises receiving, into a capacity planning system, workload information representing an expected workload of client accesses of streaming media files from a site. The capacity planning system determines a heterogeneous clustered media server solution that is capable of supporting the expected workload in a desired manner, wherein the planning system determines, for each of a plurality of different server configurations included in the heterogeneous clustered media server solution, how many servers to include in the heterogeneous clustered media server solution.

According to at least one embodiment, a method comprises a capacity planning system determining at least one heterogeneous cluster to evaluate. The method further comprises the capacity planning system determining, for each server included in the determined at least one heterogeneous cluster, a weight to be assigned such server for use by a weighted load balancing technique for optimally balancing distribution of a received workload within the determined at least one heterogeneous cluster.

According to at least one embodiment, a method comprises receiving, into a capacity planning system, workload information representing an expected workload of client accesses of streaming media files from a site. The method further comprises receiving, into the capacity planning system, at least one service parameter. The capacity planning system determines at least one heterogeneous cluster to evaluate. For a first heterogeneous cluster to evaluate, the capacity planning system determines a portion of the expected workload to be dispatched to each type of server included in the first heterogeneous cluster, and the capacity planning system computes a service demand for each type of server in the first heterogeneous cluster under its respective portion of the expected workload. The capacity planning system determines from the computed service demands whether the first heterogeneous cluster has sufficient capacity for supporting the expected workload in accordance with the at least one service parameter, and the capacity planning system outputs information indicating whether the first heterogeneous cluster is determined to have sufficient capacity for supporting the expected workload in accordance with the at least one service parameter.

According to at least one embodiment, a method comprises receiving, into a capacity planning system, workload information representing an expected workload of client accesses of streaming media files from a site. The method further comprises receiving, into the capacity planning system, at least one service parameter. The capacity planning system determines a plurality of different server configuration types to be included in a heterogeneous cluster for servicing the expected workload. For the heterogeneous cluster, the capacity planning system determines a portion of the expected workload to be dispatched to each type of server included therein, and the capacity planning system computes a service demand for each type of server in the heterogeneous cluster under its respective portion of the expected workload. The capacity planning system determines from the computed service demands a number of nodes of each type of server to be included in the heterogeneous cluster to have sufficient capacity for supporting the expected workload in accordance with the at least one service parameter, and the capacity planning system outputs information indicating the determined number of nodes.

According to at least one embodiment, a system comprises means for receiving workload information representing an expected workload of client accesses of streaming media files from a site. The system further comprises means for evaluating whether a heterogeneous cluster that includes a plurality of different types of server configurations therein provides sufficient capacity for supporting the expected workload in a desired manner.

According to at least one embodiment, a system comprises a media profiler operable to receive workload information for a service provider's site and generate a workload profile for each of a plurality of different types of server configurations included in a heterogeneous cluster under consideration for supporting the service provider's site. The system further comprises a capacity planner operable to receive the generated workload profiles for the server configurations of the heterogeneous cluster under consideration and evaluate whether the heterogeneous cluster provides sufficient capacity for supporting the site's workload.

According to at least one embodiment, computer-executable software code stored to a computer-readable medium is provided, where the computer-executable software code comprises code for receiving workload information representing an expected workload of client accesses of streaming media files from a site. The computer-executable software code further comprises code for evaluating a heterogeneous clustered media server that includes a plurality of different types of server configurations therein to determine whether the heterogeneous clustered media server under evaluation provides sufficient capacity for supporting the expected workload in a desired manner.

### BRIEF DESCRIPTION OF THE DRAWINGS

FIG. 1 shows a block diagram of an example embodiment of a capacity planning tool;

FIG. 2 shows a block diagram of another example embodiment of a capacity planning tool;

FIG. 3 shows one example of a workload profile that may be generated by a media profiler in accordance with one embodiment;

FIG. 4 shows another example of a workload profile that may be generated by a media profiler in accordance with one embodiment;

FIG. 5 shows an example of requests for file accesses that are made to a media server during an interval of time;

FIG. 6 shows an example embodiment wherein workload information is received by a media profiler, which produces a plurality of media workload profiles MP₁, MP₂, . . . , MPₖ for server configurations having different memory sizes M₁, M₂, . . . , Mₖ;

FIGS. 7A-7B show example service demand profiles that may be computed by a capacity planner from a received workload profile in accordance with one embodiment;

FIG. 8 shows an operational flow diagram for certain embodiments of a capacity planning tool that is operable to evaluate capacity of a heterogeneous cluster;

FIG. 9 shows another example operational flow diagram for certain embodiments of a capacity planning tool;

FIG. 10A shows an example of one embodiment of a capacity planning system for determining how many servers of each of a plurality of different configuration types are needed for supporting an expected workload;

FIG. 10B shows an example of re-generating a workload profile for a cluster of servers of a plurality of different configuration types in accordance with the example embodiment of FIG. 10A;

FIG. 11 shows an example operational flow diagram of one implementation of the embodiment of FIGS. 10A-10B;

FIG. 12A shows an example of one embodiment of a capacity planning system, wherein a user (e.g., a service provider) inputs information specifying plurality of different types of server configurations to be considered and service parameters;

FIG. 12B shows an example of a heterogeneous media server cluster that the service provider may implement in accordance with the solution provided by the capacity planning system of FIG. 12A;

FIG. 13 shows another example embodiment of a capacity planning system, wherein a user (e.g., a service provider) inputs information identifying a plurality of different server configurations and/or load balancing strategies to be evaluated, as well as specifying service parameters;

FIG. 14 shows an operational flow diagram of one embodiment for using a capacity planning tool; and

FIG. 15 shows an example computer system adapted to provide an embodiment of a capacity planning system.

### DETAILED DESCRIPTION

Various embodiments of a capacity planning tool (which may also be referred to herein as a “server configuration evaluator”) are now described with reference to the above figures, wherein like reference numerals represent like parts throughout the several views. An example system and method for evaluating media server capacity is provided in co-pending and commonly assigned U.S. patent application Ser. No. 10/738,273 (hereafter “the '273 application”) entitled “SYSTEM AND METHOD FOR DETERMINING HOW MANY SERVERS OF AT LEAST ONE SERVER CONFIGURATION TO BE INCLUDED AT A SERVICE PROVIDER'S SITE FOR SUPPORTING AN EXPECTED WORKLOAD.” For instance, certain embodiments of the '273 application provide a capacity planning tool for determining how many servers of at least one server configuration should be included at a service provider's site for supporting an expected workload. This capacity planning tool works particularly well for determining a cluster size of homogeneous servers. For instance, the capacity planning tool can determine, for an expected workload, the number of servers of a first type “A” (e.g., having a first memory size, disk configuration and speed, processor speed, bandwidth, etc.) that may be clustered together in order to support the workload in a desired manner, and the capacity planning tool can also determine the number of servers of a second type “B” (e.g., having a second memory size, disk configuration and speed, processor speed, bandwidth, etc.) that may be clustered together in order to support the workload in the desired manner. Thus, an evaluation can be made regarding the relative cost, capacity, etc. of the resulting homogeneous cluster solutions (i.e., the cluster solution of servers of type A and the cluster solution of servers of type B) to determine the best (e.g., most cost effective) solution to implement at the service provider's site.

Certain embodiments provided herein extend the capacity planning tool of the '273 application to enable evaluation of heterogeneous servers (of different compute power and capacity) that may be clustered together for supporting the expected workload. For instance, in accordance with certain embodiments provided herein, the capacity planning tool is operable to evaluate the capacity of a cluster having a mix of servers of type A and type B to determine the appropriate mix of such servers (i.e., the appropriate number of servers of each type) to be included in the cluster for supporting the expected workload in a desired manner.

Suppose, for example, that a service provider already has in place a cluster of 3 nodes of servers of type A. Further suppose that the service provider desires to increase capacity of the cluster to support its expected workload in a desired manner, and while the service provider is willing to consider adding a different type of server into its existing cluster, the service provider desires a solution that makes use of its existing equipment (i.e., the 3 nodes of server type A in this example). As described further below, certain embodiments of the capacity planning tool provided herein are operable to evaluate not only homogeneous cluster solutions, but also heterogeneous cluster solutions. Thus, the capacity planning tool of certain embodiments can evaluate, for the service provider's expected workload, the best (e.g., most cost effective) solution of a homogeneous cluster having all servers of type A for supporting the workload in a desired manner (e.g., in accordance with service parameters specified by the service provider) to determine the number of servers of type A to be added to the service provider's existing cluster, and the capacity planning tool can also determine the best solution of a heterogeneous cluster having the 3 existing nodes of server type A along with additional servers of type B for supporting the workload in a desired manner. Thus, an evaluation can be made regarding the relative cost, capacity, etc. of the resulting homogeneous and heterogeneous cluster solutions to determine the best (e.g., most cost effective) solution to implement at the service provider's site. Various other types of scenarios may arise in which an evaluation of a cluster solution having a heterogeneous mix of servers therein may be desired, and embodiments of the capacity planning tool described herein may be used for evaluating such heterogeneous mix in any such scenario.

Various embodiments are provided herein below for evaluating capacity of a heterogeneous clustered media server solution to determine if such solution has sufficient capacity for supporting an expected workload in a desired manner. According to one embodiment, a finite number of each of a plurality of different types of servers is known. For instance, for different server configurations S₁, S₂, and S₃, a maximum number of nodes of each server type that is available for use in a heterogeneous media server solution is known. For example, it may be known that a service provider has available 10 nodes of server S₁, 8 nodes of server S₂, and 5 nodes of server S₃. In one embodiment, this finite number of heterogeneous servers is evaluated to determine one or more solutions (e.g., homogeneous and/or heterogeneous clustered media server solutions) that can be used for supporting the service provider's expected workload in a desired manner.

According to another embodiment, a finite number of each server configuration type is not known, but instead an upper limit of the number of each server configuration type that may be required is determined by determining a homogeneous solution for each server configuration type. For instance, a determination can be made as to the number of S₁ servers to be included in a homogeneous clustered media server for supporting the expected workload in a desired manner, the number of S₂ servers to be included in a homogeneous clustered media server for supporting the expected workload in a desired manner, and the number of S₃ servers to be included in a homogeneous clustered media server for supporting the expected workload in a desired manner. For example, suppose that a determination is made that a homogeneous cluster of 15 nodes of server S₁, a homogeneous cluster of 12 nodes of server S₂, and a homogeneous cluster of 10 nodes of server S₃ are each capable of supporting the expected workload in a desired manner. This provides an upper bound of the number nodes of each server type that may be required for supporting the expected workload in a desired manner. To determine a heterogeneous mix of such servers S₁, S₂, and S₃ that is capable of supporting the expected workload in a desired manner, an initial cluster may be formed having the number of each server type of its respective homogeneous solution (e.g., 15 nodes of server S₁, 12 nodes of server S₂, and 10 nodes of server S₃ in the above example), and this heterogeneous mix may be gradually reduced to determine a proper heterogeneous solution.

According to another embodiment, a service provider may have an existing cluster of nodes of at least a first type (e.g., 10 nodes of server S₁) and various additional servers to be added to the existing cluster, resulting in a homogeneous or heterogeneous clustered solution, may be evaluated to determine one or more solutions capable of supporting the service provider's expected workload in a desired manner. For instance, suppose the service provider has an existing cluster of 10 nodes of server S₁ and desires to increase the capacity of this cluster by adding to this cluster additional servers of types S₁, S₂, and/or S₃. Certain embodiments of the capacity planning tool described herein are capable of evaluating various homogeneous solutions (i.e., solutions in which additional nodes of server type S₁ are added to the existing cluster of S₁ nodes) and/or heterogeneous solutions (i.e., solutions in which one or more servers of types S₂, and/or S₃ are added to the existing cluster of S₁ nodes) to identify those solutions capable of supporting the service provider's expected workload in a desired manner. The various solutions can then be compared by the service provider and/or capacity planning tool based on relative cost, capacity, etc. to determine the optimal solution for the service provider to implement.

Various other techniques for evaluating a heterogeneous mix of servers in a clustered media server may be employed in accordance with the capacity planning tool described herein. For instance, in certain embodiments, any combination of heterogeneous servers desired to be evaluated can be input to the capacity planner, which can in turn determine a proper weighted load-balancing strategy to utilized for such combination and evaluate whether the combination has sufficient capacity to support an expected workload in a desired manner (e.g., in accordance with service parameters specified by the service provider). Any technique for arriving at the combination(s) desired to be evaluated now known or later discovered may be employed, and an embodiment of the capacity planner described herein may be used for evaluating the capacity of such combination(s).

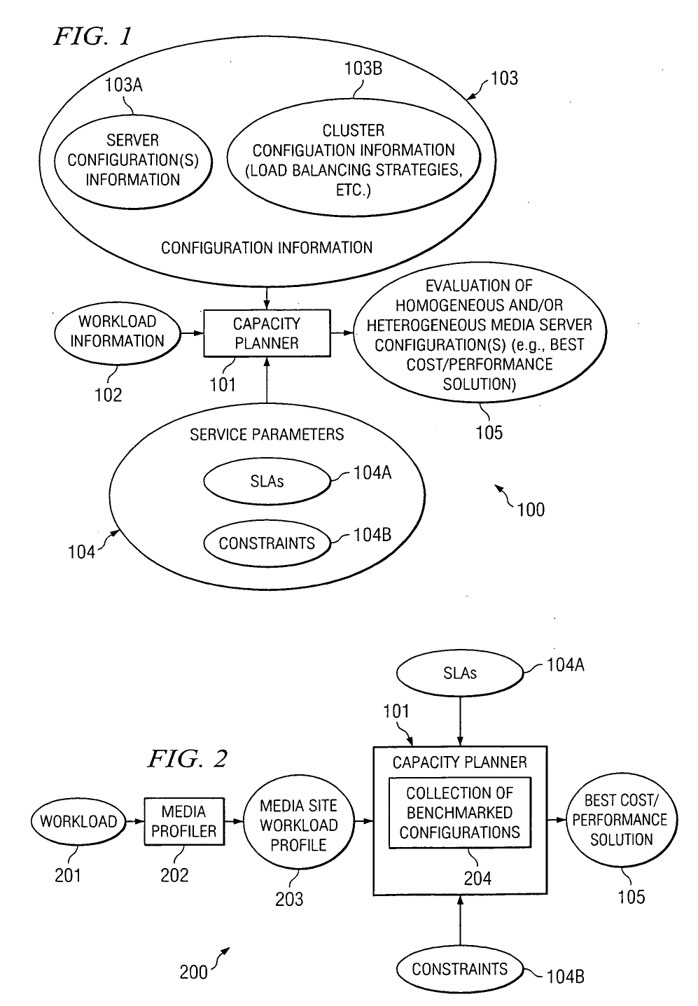

FIG. 1 shows a block diagram of an example embodiment of a capacity planning tool. As shown, system 100 includes capacity planner 101, which is capable of receiving input information regarding at least one server configuration and an expected (or “forecast”) workload. Capacity planner 101 is further operable to make an evaluation of such server configuration(s) under the expected workload, as described further below.

In certain embodiments described below, capacity planner 101 is capable of determining how many servers of particular configurations under consideration are needed for forming a heterogeneous cluster of such servers for supporting the expected workload in a desired manner. More specifically, for a mix of different server (or “node”) configurations, capacity planner 101 is operable to determine the number of each server (or “node”) type that are needed for supporting the expected workload in a desired manner. For certain expected workloads, a single server may be capable of supporting such workloads in a desired manner. Thus, clustering of a plurality of such servers may be unnecessary for achieving the desired capacity. However, a single server configuration may not be capable of supporting certain other workloads (e.g., the workloads may overload the single server). That is, a site's expected workload may be too great to be adequately supported in the manner desired by the service provider by a single server. In the cases in which a single server is unable to support the expected workload in a desired manner, a plurality of such servers may be clustered together to increase the capacity of the resulting cluster. Further, different types of servers may be clustered together to form a heterogeneous cluster solution. As described further below, in certain embodiments capacity planner 101 is operable to take into consideration one or more load balancing strategies (e.g., round-robin, weighted round-robin, LARD, etc.) that may be used by the cluster solution.

Thus, capacity planner 101 can aid a service provider in determining a proper media server configuration to be implemented for supporting its expected workload. For instance, in certain embodiments a service provider specifies a given server configuration (or a plurality of different server configurations to be considered) and load balancing strategy desired to be utilized, and capacity planner 101 determines how many of such servers of the specified configuration type(s) are to be clustered together for supporting the service provider's expected workload in a desired manner when the specified load balancing strategy is utilized for the cluster. In certain other embodiments, the service provider specifies a given server configuration (or a plurality of different server configurations) to be considered, and capacity planner 101 determines the number such servers of the specified configuration type(s) to be clustered together and a proper load balancing strategy (e.g., a proper weighted round-robin strategy) for the cluster to employ for supporting the service provider's expected workload in a manner that satisfies service parameters specified by the service provider.

Thus, the service provider can intelligently determine how many servers of the specified configuration type(s) to implement in the media server cluster for supporting the service provider's site. As described further below, the capacity planner 101 is operable to evaluate a heterogeneous cluster having a mix of servers of different configuration types. Thus, for instance, in at least one embodiment, capacity planner 101 may receive input indicating a number and type of nodes that a service provider desires to include in the cluster solution (e.g., the service provider's existing equipment), and capacity planner 101 evaluates various combinations of other types of server nodes that may be clustered with the input nodes to determine one or more suitable heterogeneous cluster solutions capable of supporting the service provider's expected workload in a desired manner. In other embodiments, the service provider may specify a plurality of different server configurations to be evaluated, and the capacity planning tool evaluates all possible combinations of the different server configurations, including homogeneous solutions and heterogeneous solutions, to determine each solution that is capable of supporting the service provider's expected workload in a desired manner. The service provider, or in some instances the capacity planning tool itself, can make comparisons of the relative cost, capacity, performance, etc. of the various solutions to determine the optimal solution for the service provider's site.

In certain embodiments, capacity planner 101 evaluates a plurality of different server configurations and/or a plurality of different load balancing strategies to determine various different solutions that are each capable of supporting the service provider's expected workload in a desired manner (e.g., in accordance with certain service parameters, as discussed further below). For instance, capacity planner 101 may determine that each of the following media server configurations are capable of supporting the service provider's expected workload in the manner desired by the service provider: 1) a homogeneous cluster of 4 servers of configuration type A using load balancing strategy X; 2) a homogeneous cluster of 5 servers of configuration type A using load balancing strategy Y; 3) a heterogeneous cluster having 2 servers of configuration type A and 7 servers of configuration type B using load balancing strategy X; 4) a heterogeneous cluster having 3 servers of configuration type A and 4 servers of configuration type B using load balancing strategy Y; etc. The service provider may then compare the monetary costs, as well as other characteristics, of each solution (i.e., each media server configuration), to identify an optimal solution for its site. In certain embodiments, capacity planner 101 includes monetary cost information for each server configuration such that it is capable of making this comparison for the service provider. In this manner, and as described further below, capacity planner 101 greatly aids a service provider in intelligently determining a media server configuration to be implemented for supporting the service provider's expected workload.

In the example of FIG. 1, workload information 102 is received by capacity planner 101. Such workload information may comprise information about a workload of client accesses to one or more streaming media files being served by a media server. In certain implementations the workload information may be actual past access logs collected by a service provider, or it may be an estimated workload that is expected. For instance, media service providers typically collect media server access logs, which reflect processed client requests and client activities at the site. A log of client accesses over a past period of say, 3 months to a year, may provide a representative “view” of the service provider's regular workload, and thus may be used as an “expected” workload for the service provider. From such a log of client accesses, a determination can be made as to the number of concurrent client accesses to a streaming media file from a media server at any given point in the time period for which client accesses were logged. As described further below in conjunction with FIG. 2, in certain embodiments such access log information may be processed to generate a workload profile for the service provider, and the generated workload profile may be used by capacity planner 101 in evaluating the server configuration(s) under consideration.

Further, capacity planner 101 may receive configuration information 103, such as server configuration information 103A (which may be referred to herein as “system configuration information” or “node configuration information”) and cluster configuration information 103B shown in the example of FIG. 1. Cluster configuration information 103B may include information about different configurations for clusters that may be used in implementing a clustered media server, such as different load balancing strategies (e.g., round-robin, LARD, etc.) that may be employed for a cluster. Server configuration information 103A may comprise information about one or more server (or “node”) configurations (such as configurations S₁, S₂, S₃, etc.), such as the respective memory size, disk configuration and speed, processor speed, bandwidth, etc. for a corresponding server configuration. In certain implementations, the server configuration information 103A may also include monetary cost information (or “price”) of a corresponding server configuration. Such monetary cost information may be used by capacity planner 101 in certain implementations for evaluating server configurations to determine a most cost-effective media server configuration (e.g., a single server configuration or cluster of a plurality of server configurations) that is capable of supporting the received workload in a manner desired by the service provider (e.g., in accordance with defined service parameters, such as those discussed further below).

As described further below, server configuration information 103A may also include benchmark information, such as the benchmark information described in co-pending U.S. patent application Ser. No. 10/306,279 (hereafter “the '279 application”) filed Nov. 27, 2002 entitled “SYSTEM AND METHOD FOR MEASURING THE CAPACITY OF A STREAMING MEDIA SERVER.” The '279 application discloses a set of benchmarks for measuring the basic capacities of streaming media systems. The benchmarks allow one to derive the scaling rules of server capacity for delivering media files which are: i) encoded at different bit rates, and ii) streamed from memory versus disk. As the '279 application further describes, a “cost” function can be derived from the set of basic benchmark measurements. This cost function may provide a single value to reflect the combined resource requirement such as CPU, bandwidth, and memory to support a particular media stream depending on the stream bit rate and type of access (e.g., memory file access or disk file access).

Further, capacity planner 101 may receive service parameters 104, which may include service level agreements (SLAs) 104_{A} and/or constraints 104_{B}, as examples. Service parameters 104 define certain characteristics of the type of service desired to be provided by the service provider under the expected workload. For instance, SLAs 104_{A} may include information identifying at least one performance criteria for the service, such as the desired media server configuration is one capable of supporting the expected workload at least X % (e.g., 99%) of the time. For example, SLA 104_{A} may specify that when presented the expected workload, the desired server configuration is overloaded to the point that it is unable to support the number of concurrent streams that it is serving (thus degrading the quality of service of one or more of those streams) no more than 1% of the time. Constraints 104_{B} may include information restricting, for example, the amount of time that the desired media server configuration is at or near its capacity under the expected workload. For example, a constraint may be defined specifying that the media server configuration desired by the service provider is utilized under 70% of its capacity for at least 90% of the time under the expected workload. Such constraint may, for example, allow the service provider to define a certain amount of over-capacity into the desired media server configuration to enable future growth of the workload to be supported by the server. The service parameters 104 may, in certain implementations, be variables that can be defined by a service provider.

Capacity planner 101 is operable to evaluate one or more configurations 103, such as may be identified by server configuration information 103A and/or cluster configuration information 103B, under the received workload 102, and capacity planner 101 outputs an evaluation 105 of such one or more media server configurations. More specifically, evaluation 105 may include an evaluation of the capacity of one or more media server configurations formed using the one or more server configurations under consideration for supporting the expected workload 102. For instance, such evaluation 105 may identify a plurality of different homogeneous and/or heterogeneous media server configurations that are each capable of supporting workload 102 in accordance with the defined service parameters 104. For example, suppose that server configuration information 103A includes information for two different server configuration types, A and B, and cluster configuration information 103B includes information for two different load balancing strategies, X and Y; in certain embodiments, capacity planner 101 outputs evaluation 105 identifying the following different media server configurations that are each capable of supporting a service provider's expected workload 102 in accordance with the defined service parameters 104: 1) a homogeneous cluster of 4 servers of configuration type A using load balancing strategy X; 2) a homogeneous cluster of 5 servers of configuration type A using load balancing strategy Y; 3) a heterogeneous cluster having 2 servers of configuration type A and 7 servers of configuration type B using load balancing strategy X; and 4) a heterogeneous cluster having 3 servers of configuration type A and 4 servers of configuration type B using load balancing strategy Y. In certain embodiments, the capacity planner is operable to determine proper weighting for each node of a solution to be employed in a weighted load-balancing strategy (e.g., weighted round-robin). Techniques that may be employed for determining optimal weights to be used in a weighted load balancing technique for a given heterogeneous cluster under evaluation are described further below. Further, in certain implementations, evaluation 105 may provide a comparison of the capacities of the various different media server configurations for supporting the expected workload 102, as well as the monetary cost of each media server configuration. From this information, a service provider may make an informed decision regarding the best media server configuration to be implemented for supporting the service provider's future workload. For instance, the service provider may, in certain implementations, determine the most cost-effective media server configuration, which may be a single server of a particular configuration type, a homogeneous cluster of servers of a particular configuration type that use a particular load balancing strategy, or a heterogeneous cluster of servers of different configuration types using a particular load balancing strategy for supporting the expected workload in a desired manner.

For evaluating the capacity of a server configuration under the expected workload, certain embodiments provided herein use a “cost” function for evaluating the amount of resources of the server configuration that are consumed under the workload. That is, in certain embodiments capacity planner 101 is operable to compute a “cost” in terms of server resources consumed for supporting the workload. This cost function, which is described further below in conjunction with the example of FIG. 2, may provide a single value to reflect the combined resource requirement such as CPU, bandwidth, and memory to support a particular media stream depending on the stream bit rate and type of access (e.g., memory file access or disk file access). In general, this cost function is used to compute the cost (in terms of resources consumed) of serving a stream (request) depending on its type: 1) its encoding bit rate, and 2) its access type (memory versus disk). Capacity planner 101 can evaluate the computed cost of a given server configuration to evaluate whether the server configuration can support the workload in accordance with the service parameters 104.

The ability to plan and operate at the most cost effective capacity provides a desirable competitive advantage for many streaming media service providers. Consider, for example, a scenario where a service provider, supporting a busy media site, faces a necessity to migrate the site to a new, more efficient infrastructure. For example, it may be determined that the service provider's current media server configuration is unable to adequately support the service provider's regular workload, and thus a new media server configuration is desired. The challenge becomes determining the optimal or most cost-effective infrastructure for the service provider to implement. On the one hand, the service provider typically desires to implement a media server configuration that is capable of supporting the service provider's workload (at least for a majority of the time) such that a desired quality of service is maintained for the streams that it serves. However, the service provider also typically desires to minimize the monetary cost of the media server configuration. For instance, as mentioned above, in some situations the service provider may desire to continue making use of its existing equipment in the resulting solution (e.g., by adding additional nodes to the already existing nodes of a clustered media server). Thus, the service provider typically does not wish to select a media server configuration that will be capable of supporting the service provider's workload at a cost of $X dollars, while a media server configuration that costs much less would be capable of supporting the service provider's workload just (or almost) as well. The service provider traditionally has no tool for evaluating the manner in which each of the media server configurations being considered would support the service provider's expected workload. Thus, the service provider traditionally makes a relatively uninformed decision regarding which media server configuration to implement for supporting the service provider's site. For instance, the service provider traditionally makes a relatively uninformed decision regarding the capacity of a solution resulting from adding certain server node(s) to the service provider's already existing nodes.

Typically, the relationship between various media server configurations (e.g., either homogeneous or heterogeneous clustered solutions) and their respective abilities to support a service provider's workload is not fully understood or appreciated by the service provider, thereby making the decision of selecting a media server configuration difficult. Accordingly, a capacity planning tool, such as capacity planner 101 of FIG. 1, that is capable of evaluating media server configurations for a workload and provide feedback regarding the capacity of such configurations for supporting the workload and/or identifying the most cost-effective configuration is a beneficial tool for service providers.

Turning to FIG. 2, a block diagram of another example embodiment of a capacity planning tool is shown. As with the example embodiment of FIG. 1, system 200 includes capacity planner 101, which may receive, as input, service parameters defining certain characteristics of the type of service desired to be provided by the service provider under the expected workload, such as SLAs 104A and constraints 104B.

In the example of FIG. 2, a media profiler 202 (referred to herein as “MediaProf”) is implemented. Such MediaProf 202 receives workload information 201 and generates a workload profile 203 for the service provider's workload. As mentioned above, media service providers typically collect media server access logs, which reflect processed client requests and client activities at the service provider's site. In the example of FIG. 2, workload 201 comprises such an access log (which may be from a single server or from a cluster of servers at the service provider's site, depending on the service provider's current media server configuration) for an elapsed period of say, 3 months to a year. The access log may include information for any suitable elapsed period of time that is sufficiently long to provide a representative “view” of the service provider's regular (or typical) workload. Alternatively, workload 201 may be a synthetic or estimated workload that is representative of the workload expected for the service provider's site.

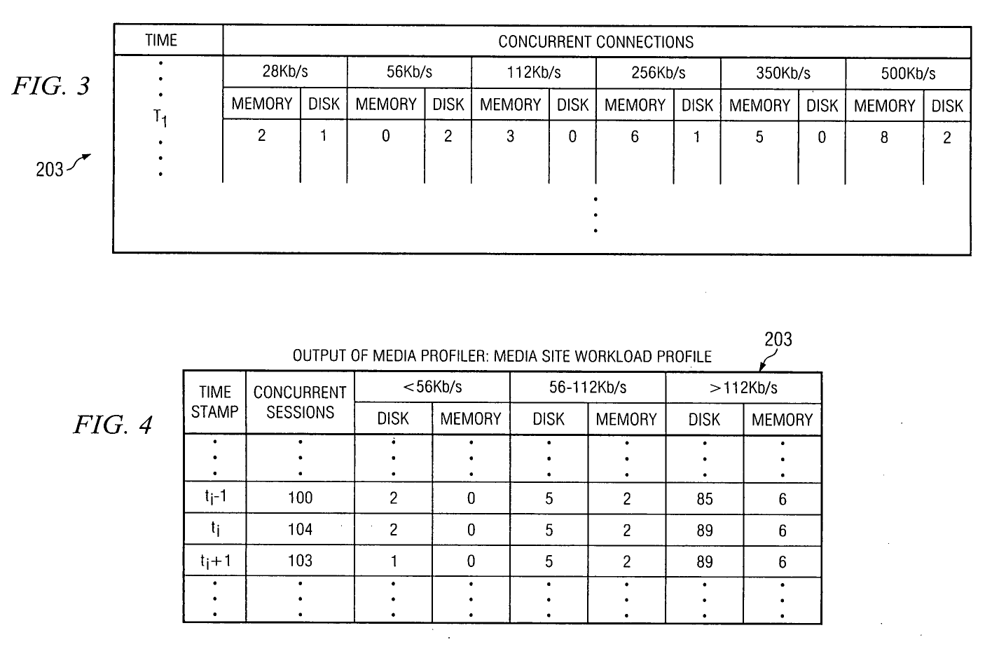

MediaProf 202 receives this workload information (e.g., access log) 201 and processes such workload information 201 to generate a workload profile 203 for the service provider. Such workload profile 203 is then received by capacity planner 101 and used thereby for evaluating one or more server configurations under consideration. In certain implementations, MediaProf 202 processes the access log collected for a service provider's site to characterize the site's access profile and its system resource usage in both a quantitative and qualitative way in the workload profile 203. Examples of workload profile 203 that may be generated by MediaProf 202 according to certain implementations are described further below in conjunction with FIGS. 3 and 4. As described further with FIGS. 3 and 4, in certain embodiments workload profile 203 identifies the access types of requests (e.g., memory versus disk) in the workload for a given server configuration under consideration. Thus, MediaProf 202 may generate a different workload profile 203 for different server configurations (e.g., having different memory sizes) for the given workload 201.

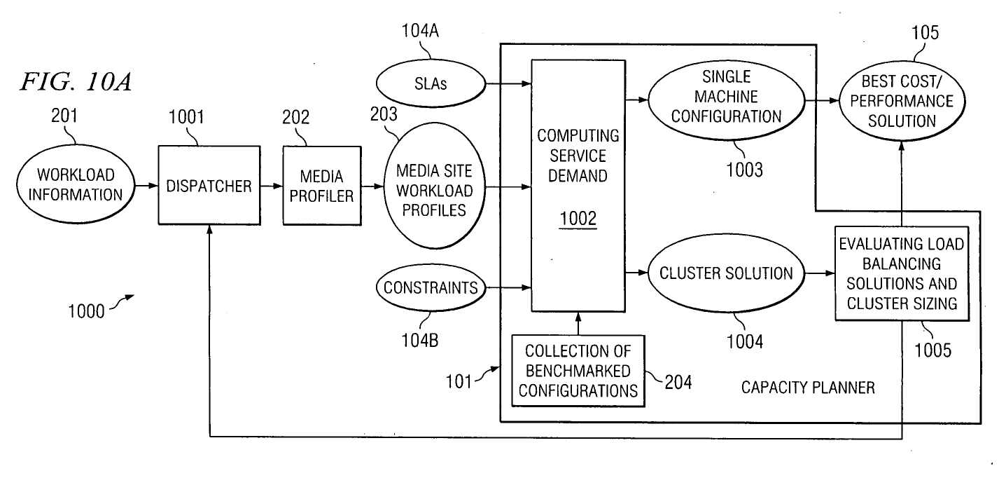

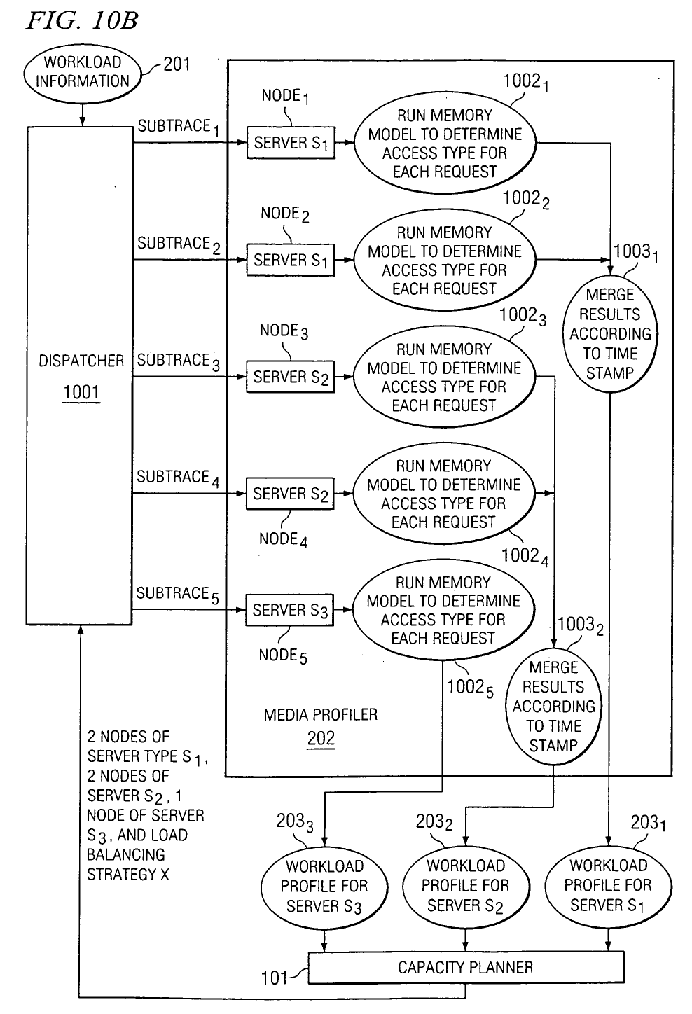

As described further below with FIG. 10A, a dispatcher may be used to dispatch the requests from workload 201 (e.g., the access log) to each server of a given media server configuration in accordance with a specified load balancing technique, and MediaProf 202 determines a workload profile for each of the servers in the media server configuration under evaluation. For example, suppose a media server configuration having 3 nodes of configuration “A” and 2 nodes of configuration “B” is under evaluation, a dispatcher dispatches requests of the workload 201 to each of the 5 nodes of the media server configuration in accordance with a specified load balancing technique (e.g., weighted round-robin, etc.). Thus, a corresponding sub-workload is dispatched to each of the 5 nodes. Given the respective requests (included in the respective sub-workloads) sent to each of the 5 nodes, MediaProf 202 determines a sub-workload profile for each of such 5 nodes. The sub-workload profiles for the servers of like types are then merged to form a workload profile for each server type. For instance, the sub-workload profiles for the 3 nodes of configuration A are merged to form a workload profile for the servers of type A, and the sub-workload profiles for the 2 nodes of configuration B are merged to form a workload profile for the servers of type B. Capacity planner 101 receives the workload profiles of each server type and uses these profiles for evaluating the capacity of this 5-node heterogeneous media server configuration for supporting the expected workload 201 of the service provider's site.

In the example embodiment of FIG. 2, capacity planner 101 has the ability to measure and to compare the capacities of different media server configurations. More specifically, in this example embodiment capacity planner 101 uses a cost function for evaluating the capacities of various different server configurations under the workload. As mentioned above, a technique for measuring server capacity using a cost function is disclosed in the '279 application. Also, a technique for measuring server capacity using a cost function is described by L. Cherkasova and L. Staley in “Building a Performance Model of Streaming Media Applications in Utility Data Center Environment”, Proc. of ACM/IEEE Conference on Cluster Computing and the Grid (CCGrid), May, 2003 (hereinafter referred to as “the L. Cherkasova Paper”), the disclosure of which is hereby incorporated herein by reference. The above references introduce a basic benchmark that can be used to establish the scaling rules for server capacity when multiple media streams are encoded at different bit rates. For instance, a basic benchmark may be executed for each of various different encoding bit rates for files stored at a media server.

A media server (which may be either a single server or a cluster of servers) may comprise streaming media files that are encoded for transmission at each of a plurality of different bit rates. For example, a first streaming media file, “File A,” may comprise a particular content and it may be encoded for transmission at a plurality of different bit rates, such as 28 Kb/s, 56 Kb/s, and/or various other bit rates. Each resulting version of the file encoded for transmission at a given bit rate may be stored to data storage of the media server and the media server may be able to serve the appropriate one of such files as a stream to a client. In this case, the different encoded files comprise substantially the same content (i.e., the content of File A), but are encoded for transmission at different bit rates, and thus the quality of each file may differ. A media server generally attempts to serve the most appropriate encoded file to a client based at least in part on the client's access speed to the client-server network. For example, suppose a first client has a 28 Kb/s speed connection to the communication network (e.g., the Internet), a second client has a 56 Kb/s speed connection to the communication network, and a media server comprises File A₁ encoded at 28 Kb/s and File A₂ encoded at 56 Kb/s stored thereto; when the first client requests the content of File A, the media server typically attempts to serve File A₁ to this first client (as File A₁ is the highest-quality encoded file supportable by the first client's connection speed), and when the second client requests the content of File A, the media server typically attempts to serve File A₂ to this second client (as File A₂ is the highest-quality encoded file supportable by the second client's connection speed).

As used herein, a file encoded for transmission at a particular bit rate may be referred to as a file encoded at the particular bit rate. In common phraseology in the art, a streaming media file is referred to as being “encoded at a particular bit rate”, which means the file is encoded for transmission from the server at the particular bit rate. Thus, as used herein, the phrase “encoded at a bit rate” when describing a streaming media file means the streaming media file is encoded for transmission at the bit rate, as is consistent with common phraseology in the streaming media art.

As shown in the example of FIG. 2, capacity planner 101 may have stored thereto (e.g., to a data storage device, such as random access memory (RAM), hard disk, optical disk drive, etc., which is communicatively accessible by capacity planner 101) server configuration information 204, such as server configuration information 103A in the example of FIG. 1. Although not specifically shown in FIG. 2, capacity planner 101 may also include cluster configuration information 103B of FIG. 1. In this example, server configuration information 204 includes benchmark information for various different server configurations, such as the benchmark information described in the '279 application. An objective of the basic benchmark according to one embodiment is to define how many concurrent streams of the same bit rate can be supported by the corresponding server configuration without degrading the quality of any streams.

In accordance with one embodiment, the basic benchmark comprises two types of benchmarks:
1) Single File Benchmark measuring a media server capacity when all the clients in the test workload are accessing the same file, and
2) Unique Files Benchmark measuring a media server capacity when each client in the test workload is accessing a different file. Each of these benchmarks have a set of sub-benchmarks with media content encoded at a different bit rate. In one performance study that we have conducted, the following six bit rates that represent the typical Internet audience were used: 28 Kb/s, 56 Kb/s, 112 Kb/s, 256 Kb/s, 350 Kb/s, and 500 Kb/s. Of course, the set of benchmarked encoding bit rates can be customized according to a targeted workload profile, and thus other encoding bit rates instead of or in addition to those of our performance study may be used in various embodiments.

Thus, a Single File Benchmark (SFB) may be executed for each of various different encoding bit rates for files stored at a server configuration under evaluation. The SFB measures the server capacity when all of the clients in the test are accessing the same file. That is, the result of the SFB for a particular encoding bit rate defines the maximum number of concurrent streams of a single file encoded at that particular bit rate that the corresponding server configuration can support. Example techniques for executing SFBs for a media server are described further in the '279 application. In this example embodiment of FIG. 2, an SFB is determined for each of various different server configurations, and such SFB determined for each server configuration is included in the collection of benchmarks 204.

Similarly, a Unique Files Benchmark (UFB) may be executed for each of various different encoding bit rates for files stored at a server configuration under evaluation. The UFB measures the server capacity when all of the clients in the test are accessing different files. That is, the result of a UFB for a particular encoding bit rate defines the maximum number of concurrent streams, each of different files that are encoded at the particular bit rate, that the corresponding server configuration can support. Example techniques for executing UFBs for a media server are described further in the '279 application. In an example embodiment of FIG. 2, a UFB is determined for each of various different server configurations, and such UFB determined for each server configuration is included in the collection of benchmarks 204.

When all of a media server's clients are accessing a single file (as measured by the SFB), the media server is capable of serving the currently streamed bytes of the file from memory. However, when all of its clients are accessing a different file (as measured by the UFB), the media server serves each file from disk. Thus, the SFB is essentially a best-case scenario benchmark, whereas the UFB is essentially a worst-case scenario benchmark for a corresponding server configuration under consideration.

Using an experimental testbed with standard components available in a Utility Data Center environment and proposed set of basic benchmarks, the capacity and scaling rules of a media server running RealServer 8.0 from RealNetworks was measured in the L. Cherkasova Paper. The measurement results reported in the L. Cherkasova Paper show that these scaling rules are non-trivial. For example, the difference between the highest and lowest bit rate of media streams used in those experiments was 18 times. However, the difference in maximum number of concurrent streams a server is capable of supporting for corresponding bit rates is only around 9 times for an SFB, and 10 times for a UFB. Modem media servers, such as RealServer 8.0, rely on the native operating system's file buffer cache support to achieve higher application throughput when accessed files are streamed from memory. The measurements indicate that media server performance is approximately 3 times higher (and for some disk/file subsystems, up to 7 times higher) under the SFB than under the UFB. This quantifies the performance benefits for multimedia applications when media streams are delivered from memory versus from disk.

Capacity planner 101 uses the benchmarks for the various different server configurations to evaluate those server configurations under the received workload information (e.g., the workload profile 203). For evaluating the capacity of a server configuration under the expected workload, certain embodiments of a capacity planner use a “cost” function for evaluating the amount of resources of the corresponding server configuration under consideration that are consumed under the workload. As described in the '279 application and in the L. Cherkasova Paper, a set of basic benchmark measurements for a server configuration may be used to derive a cost function that defines a fraction of system resources of such media server configuration that are needed to support a particular media stream depending on the stream bit rate and type of access (memory file access or disk file access), including the following costs:
A) cost_{X}_{ᵢ}^{disk}—a value of cost function for a stream with disk access to a file encoded at Xᵢ Kb/s. If we define the server configuration capacity being equal to 1, the cost function is computed as cost_{X}_{ᵢ}^{disk}=1/N_{X}_{ᵢ}^{Unique} where N_{X}_{ᵢ}^{Unique} is the maximum measured server capacity in concurrent streams under the UFB of the corresponding server configuration under consideration for a file encoded at Xᵢ Kb/s; and
B) cost_{X}_{ᵢ}^{memory}—a value of cost function for a stream with memory access to a file encoded at Xᵢ Kb/s. Let N_{X}_{ᵢ}^{Single} be the maximum measured server capacity in concurrent streams under the SFB of the corresponding server configuration under consideration for a file encoded at Xᵢ Kb/s, then the cost function is computed as

$${cost}_{{X}_{i}}^{memory} = \frac{( {N}_{{X}_{i}}^{Unique} - 1 )}{( {N}_{{X}_{i}}^{Unique} \times ( {N}_{{X}_{i}}^{Single} - 1 ) )} .$$

Let W be the current workload processed by a media server, where
a) X_{w}=X₁, . . . . Xₖ_{_{w}} is a set of distinct encoding bit rates of the files appearing in W(X_{w}⊂X);
b)

$${N}_{{X}_{{W}_{i}}}^{memory}$$
is a number of streams having a memory access type for a subset of files encoded at X_{W}_{ᵢ} Kb/s; and
c)

$${N}_{{X}_{{W}_{i}}}^{disk}$$
is a number of streams having a disk access type for a subset of files encoded at X_{w}_{ᵢ} Kb/s.
Then, the service demand, “Demand,” to a server under workload W can be computed by the following capacity equation:

$$Demand = {\sum }_{i = 1}^{{K}_{W}} {N}_{{X}_{{W}_{i}}}^{memory} \times {cost}_{{X}_{{W}_{i}}}^{memory} + {\sum }_{i = 1}^{{K}_{W}} {N}_{{X}_{{W}_{i}}}^{disk} \times {cost}_{{X}_{{W}_{i}}}^{disk} \qquad ( 1 )$$

If Demand≦1 then a single-server configuration of the media server operates within its capacity, and the difference 1−Demand defines the amount of available server capacity. On the other hand, if Demand>1 then the single-server configuration of the media server is overloaded and its capacity is exceeded. For example, when the computed service demand is Demand=4.5, this indicates that the considered workload (media traffic) requires 5 nodes (of the corresponding server configuration) to be supported in the desired manner.

As described further below, in certain embodiments, an iterative approach is used by capacity planner 01 for determining media server configuration(s) that are capable of supporting the workload in a desired manner. For instance, capacity planner 101 may first use the benchmarks (SFB and UFB) and cost function for each server configuration included in a cluster under evaluation to compute the Demand for each server configuration (using the corresponding benchmarks and cost function for each respective server configuration). If the Demand indicates that more than one of the servers of the corresponding configuration type is required for supporting the expected workload, capacity planner 101 then re-evaluates the expected workload for a clustered media server configuration having the number of servers of that type as indicated by the Demand. For instance, if when evaluating the capacity of a heterogeneous clustered media server that includes a single server of a first configuration type the capacity planner computes the demand for such first configuration type of server included in the cluster as Demand=4.5 (indicating that a cluster of 5 nodes of such server configuration type is needed for supporting its allocated portion of the expected workload), capacity planner 101 re-evaluates the capacity of a clustered media server having the resources (e.g., amount of memory, etc.) of 5 of the servers of this first configuration type (in addition to any other nodes of other configuration types included in the cluster under evaluation).

Capacity planner 01 then determines the media site workload profile(s) 203 for each type of server included in the heterogeneous cluster (because the workload profile(s) 203 for the servers may differ from the workload profile(s) 203 initially determined, and capacity planner 101 uses such determined workload profile(s) 203 for each of the server configurations to compute the Demand for each server configuration. If the Demand computed for the first server configuration again indicates that 5 servers of that configuration type are needed in the heterogeneous cluster (as well as again indicating that the initially determined number of servers of each other type of server in the heterogeneous cluster), capacity planner 101 concludes that such a cluster of 5 nodes is the proper solution for supporting the expected workload. This iterative process is described further in the '273 application for determining a proper number of servers of a given server configuration, which may be extended in accordance with the embodiments herein to iteratively determine/verify the number of servers to be included in each of a plurality of different server configurations implemented in a heterogeneous cluster under evaluation.

The above-described cost function uses a single value to reflect the combined resource requirement such as CPU, bandwidth and memory to support a particular media stream depending on the stream bit rate and type of the file access (memory or disk access). The proposed framework provides a convenient mapping of a service demand (client requests) into the corresponding system resource requirements.

As mentioned with FIG. 2, workload profile(s) 203 based on the past workload history (e.g., access log) 201 of a service provider may be generated by MediaProf 202 and used by capacity planner 101 in evaluating the capacity of one or more server configurations for supporting the service provider's workload. While it may be useful to understand how much traffic is serviced by the site in a particular time interval (e.g., per hour), this knowledge does not translate directly into capacity requirements for a proper media server configuration. For properly evaluating a media server configuration's capacity for supporting a workload, information concerning the number of simultaneous (concurrent) connections and the corresponding peak bandwidth requirements may be used by capacity planner 101.

As described further in the '273 application, in the workload of many sites the amount of client requests and required bandwidth is highly variable over time, and such traffic is often “bursty” such that a large fraction of requests can be served from memory. Since a media server capacity is 3-7 times higher when media streams are delivered from memory versus from disk, such a qualitative media traffic classification and analysis directly translates in significant configuration savings.

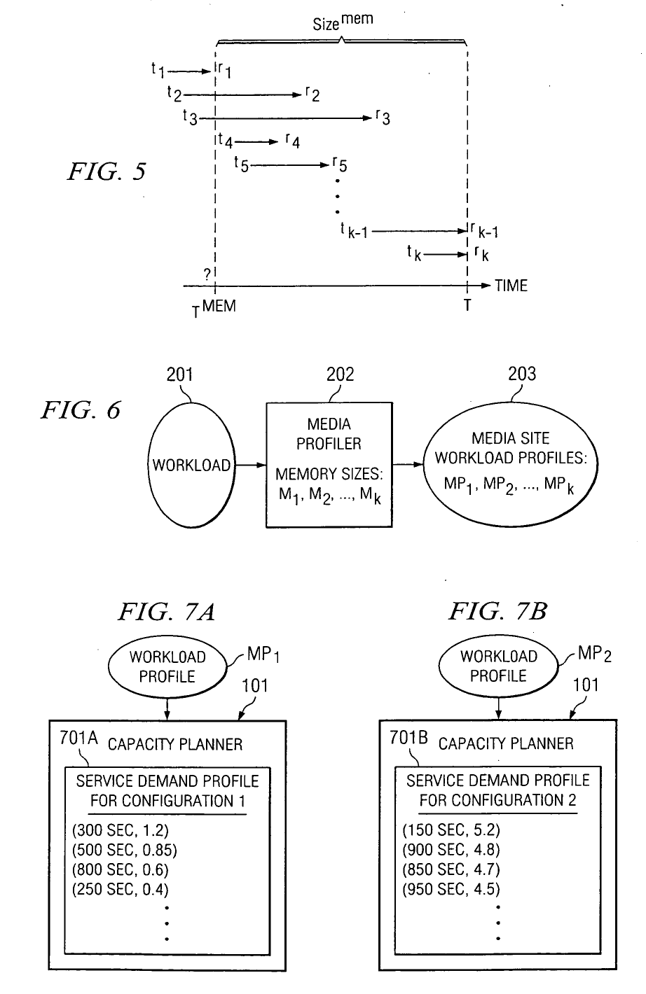

Since the amount of system resources needed to support a particular client request depends on the file encoding bit rate as well as the access type of the corresponding request (i.e. different requests have a different resource “cost” as described above), MediaProf 202 provides a corresponding classification of simultaneous connections in the generated workload profile(s) 203. FIG. 3 shows a first example workload profile 203 that may be generated by certain embodiments of MediaProf 202. As shown, the example workload profile 203 of FIG. 3 includes various points in time for which access information was collected in the access log of workload 201, such as time T₁. For each time point, the number of concurrent connections is identified. More specifically, the number of concurrent connections are categorized into corresponding encoding bit rates for the streaming media files accessed thereby. Further, the number of concurrent connections in each encoding bit rate category is further categorized into sub-categories of either memory or disk depending on whether the access was a memory access or a disk access. That is, MediaProf 202 may model whether a request in the workload can be serviced from memory or from disk for a given server configuration (e.g., a given memory size). As described further herein, the profile for each server type included in a clustered media server may be built by MediaProf 202 based on the requests of workload 201 that are directed to node(s) of each server type according to a specified load balancing strategy (e.g., weighted round-robin, etc.). Thus, for the requests of the workload 201 that are directed to a given server (or “node”) of a clustered media server configuration under evaluation, MediaProf 202 models whether each request to such given server can be serviced from memory or from disk. For instance, the memory modeling technique disclosed in co-pending and commonly assigned U.S. patent application Ser. No. 10/601,956 (hereafter “the '956 application”) titled “SYSTEM AND METHOD FOR MODELING THE MEMORY STATE OF A STREAMING MEDIA SERVER,” may be used in certain embodiments. In certain implementations, MediaProf 202 may build different profiles for different memory sizes (e.g., different profiles 203 are constructed for different media server configurations that have different memory sizes). Note that a memory access does not assume or require that the whole file resides in memory. For example, if there is a sequence of accesses to the same file issued closely to each other on a time scale, then the first access may read a file from disk, while the subsequent requests may be accessing the corresponding file prefix from memory. A technique that may be used by MediaProf 202 in determining whether an access is from memory or from disk is described further below in conjunction with FIG. 5.

In the example workload profile of FIG. 3, 30 concurrent connections (or client accesses) are in progress at time T₁ for the media site under consideration. The 30 concurrent connections are categorized into 3 accesses of media file(s) encoded at 28 Kb/s, 2 accesses of media file(s) encoded at 56 Kb/s, 3 accesses of media file(s) encoded at 112 Kb/s, 7 accesses of media file(s) encoded at 256 Kb/s, 5 accesses of media file(s) encoded at 350 Kb/s, and 10 accesses of media file(s) encoded at 500 Kb/s. Again, embodiments are not limited to the six encoding bit rate categories of the example of FIG. 3, but rather other encoding bit rates may be used instead of or in addition to those of FIG. 3 (e.g., as may be tailored for the service provider's site/workload). Further, the 3 accesses of media file(s) encoded at 28 Kb/s are further sub-categorized into 2 memory accesses and 1 disk access. The 2 accesses of media file(s) encoded at 56 Kb/s are further sub-categorized into 0 memory accesses and 2 disk accesses. The 3 accesses of media file(s) encoded at 112 Kb/s are further sub-categorized into 3 memory accesses and 0 disk accesses. The 7 accesses of media file(s) encoded at 256 Kb/s are further sub-categorized into 6 memory accesses and 1 disk access. The 5 accesses of media file(s) encoded at 350 Kb/s are further sub-categorized into 5 memory accesses and 0 disk accesses, and the 10 accesses of media file(s) encoded at 500 Kb/s are further sub-categorized into 8 memory accesses and 2 disk accesses.

Another example workload profile 203 that may be generated by certain embodiments of MediaProf 202 is shown in FIG. 4. As shown, the example workload profile 203 of FIG. 4 includes various points in time for which access information was collected in the access log of workload 201, such as timestamps tᵢ−1, tᵢ, and tᵢ+1. In this example, the timestamps show when the media server state changes, e.g., i) the media server accepts a new client request (or multiple new requests) or ii) some active media sessions are terminated by the clients. For each timestamp, the number of concurrent connections is identified. In the example of FIG. 4, there are 100 concurrent connections at timestamp tᵢ−1, 104 concurrent connections at timestamp tᵢ, and 103 concurrent connections at timestamp tᵢ+1. As with the example of FIG. 3, the number of concurrent connections are categorized into corresponding encoding bit rates for the streaming media files accessed thereby. In the example of FIG. 4, the number of the concurrent connections at any given timestamp are categorized into those connections that are accessing streaming media files encoded at less than 56 Kb/s, those that are accessing streaming media files encoded at a rate from 56 Kb/s to 112 Kb/s, and those that are accessing streaming media files encoded at greater than 112 Kb/s.

For each of these categories, the connections are further categorized into sub-categories of either memory or disk depending on whether the access was a memory access or a disk access. As described above, MediaProf 202 may model whether a request in the workload can be serviced from memory or from disk for a given server configuration (e.g., a given memory size), such as with the memory modeling technique disclosed in the '956 application. A technique that may be used by MediaProf 202 in determining whether an access is from memory or from disk is described further below in conjunction with FIG. 5.

Turning to FIG. 5, an example technique for MediaProf 202 determining an access type (i.e., whether memory or disk access) is now described. Let Size^{mem} be the size of memory in bytes of a server configuration under consideration. For each request r in the media server access log of workload 201, information is included about the media file requested by r, the duration of r in seconds, the encoding bit rate of the media file requested by r, the time t when a stream corresponding to request r is started (which is reflected by r(t) herein), and the time when a stream initiated by request r is terminated.

Let r₁ (t₁), r₂(t₂), . . . , rₖ(tₖ) be a recorded sequence of requests to a given server configuration (e.g., S₁). Given the current time T and request r(T) to media file f MediaProf 202 may compute some past time T^{mem} such that the sum of the bytes stored in memory between T^{mem} and T is equal to Size^{mem}. Accordingly, the files' segments streamed by the server configuration between times T^{mem} and T will be in memory at time T. In this way, MediaProf 202 can identify whether request r will stream file f (or some portion of it) from memory for the given server configuration under consideration.

In the specific example shown in FIG. 5, requests for file accesses that are made to the server configuration (e.g., S₁) during the interval of time t₁ through time T is shown, wherein the interval from time T^{mem} through time T can be determined that comprises the segments of accessed files that are currently stored to the server's memory, which has size Size^{mem}. More specifically, accesses r₁, r₂, . . . , rₖ₋₁, rₖ are made during the time interval from time t₁ through the current time T.

As described further below, when a clustered media server configuration is considered, a dispatcher determines the requests of workload 201 that will be directed to each server of the cluster (in accordance with a load balancing strategy employed by the cluster, such as a weighted round robin strategy), and considering memory size, Size^{mem}, of each server of the cluster, a determination is made whether each access is a memory type or a disk type. That is, the memory of each server in the cluster may be modeled in the manner described in connection with FIG. 5 to determine the corresponding access types (memory versus disk) for the requests of workload 201 that are serviced by each server of the cluster. As shown in the example of FIG. 5, the total size of the segments accessed is greater than the total size, Size^{mem}, of the server's memory. Thus, depending on the type of memory management scheme implemented for the memory, some of the accessed segments are evicted from the memory. That is, not all of the accessed segments can be stored to memory because the segments' total size is greater than size Size^{mem} of memory of the server configuration under consideration. Typically, a Least Recently Used (LRU) scheme is implemented for a media server, wherein the most recently accessed segments are stored to memory and the oldest (or least recently accessed) segments are evicted to make room for more recently accessed segments to be stored in memory. To determine the current contents of memory at time T, the time interval from time Tₘₑₙ to the time Tin which unique file segments that have a size totaling size Sizeₘₑₘ is determined by MediaProf 202 from the workload information 201.

The '956 application further describes an example technique for modeling the memory state of a streaming media server, and such memory modeling technique may be employed by MediaProf 202 in certain embodiments for efficiently determining the memory state of the server configuration(s) under consideration. That is, MediaProf 202 may use such memory modeling technique for modeling accesses of the workload 201 for each server configuration under consideration to generate a workload profile 203, such as the example workload profile of FIG. 3 or FIG. 4, for each type of server configuration under consideration.

In certain implementations, MediaProf 202 may build different profiles for different memory sizes (e.g., different profiles 203 are constructed for different server configurations that have different memory sizes). FIG. 6 shows an example embodiment wherein workload 201 is received by MediaProf 202, and MediaProf 202 produces a plurality of media workload profiles (203) MP₁, MP₂, . . . , MPₖ for specified memory sizes M₁, M₂, Mₖ. For instance, a plurality of memory sizes M₁, M₂, . . . , Mₖ may be specified to MediaProf 202 (e.g., either pre-defined, specified by user-input, specified by capacity planner 101, etc.), and using the workload 201, MediaProf 202 generates the various different media workload profiles MP₁, MP₂, . . . , MPₖ corresponding to the memory sizes. For example, media workload profile MP₁ may be generated for a server configuration S₁, media workload profile MP₂ may be generated for a server configuration S₂, and so on. In this way, MediaProf 202 allows evaluation of performance benefits of systems with different memory sizes when processing a particular workload.

In the example embodiment of FIG. 2, capacity planner 101 has a collection of benchmarked configurations 204 with the corresponding cost functions for different types of requests (i.e., requests serviced by memory versus requests serviced by disk). Capacity planner 101 receives the media site workload profile(s) 203 (for each of the server configurations included in the media server cluster under evaluation) and, using the corresponding cost functions of each of the server configurations, computes a corresponding service demand profile over time according to formula (1) above. In certain embodiments, the service demand profile is computed for different memory sizes and different benchmarked configurations to enable capacity planner 101 to evaluate the capacity of a plurality of different media server configurations for supporting the expected workload. In certain embodiments, a service demand profile is computed for each of the types of server configurations (e.g., S₁, S₂, S₃, etc.) included in the clustered media server under evaluation. An example of such a service demand profile is described further below in conjunction with FIGS. 7A-7B.

FIGS. 7A and 7B show example service demand profiles 701A and 701B that are generated by capacity planner 101 from received workload profiles 203. The workload profile 203 of FIG. 7A corresponds to a first workload profile (e.g., MP₁) for a first media server configuration (e.g., one having memory size M₁), and the workload profile 203 of FIG. 7B corresponds to a second workload profile (e.g., MP₂) for a second media server configuration (e.g., one having memory size M₂). Suppose, for example, that a given heterogeneous cluster under evaluation includes servers of the first configuration which are dispatched a first portion of workload 201 (according to a load-balancing strategy employed by the cluster), and the cluster also includes servers of the second configuration which are dispatched a second portion of workload 201 (according to the load-balancing strategy of the cluster). In this case, the workload profile MP₁ may be generated for servers of the first configuration based on the respective requests of workload 201 that are dispatched to such servers, and the workload profile MP₂ may be generated for servers of the second configuration based on the respective requests of workload 201 that are dispatched to those servers.

In the example of FIG. 7A, service demand profile 701A is a list of pairs. The first element of each pair represents a time duration (e.g. 300 seconds in the first pair of example service demand profile 701A). The second element of each pair reflects the service demand (or resource “cost”) computed by capacity planner 101 for the corresponding time duration for a media server configuration under consideration (such as media server “configuration 1” in the example of FIG. 7A, which may be a portion of an overall heterogeneous media server solution in some instances). In the example service demand profile 701A, the first pair has a service demand of 1.2 for 300 seconds, the second pair provides that a service demand 0.85 was encountered for 500 seconds, and so on. A service demand greater than 1 (e.g., 1.2 for the first pair of service demand profile 701A) means that more than 1 of the server configurations under consideration were required for supporting the workload for a corresponding amount of time (e.g., at least 1.2 of the “configuration 1” servers are needed for supporting 300 seconds of the received workload 203 in the example of the first pair of the service demand profile 701A of FIG. 7A). In other words, the server configuration under consideration was overloaded for the corresponding period of time for which the capacity planner computes that the service demand in supporting workload 203 is greater than 1. The second pair of service demand profile 701A, (500 sec, 0.85), identifies that for 500 sec of the received workload 203, one server having the “configuration 1” under consideration is capable of supporting such workload, and the server under consideration is utilized during this time at 85% capacity. Thus, if the configuration 1 is a portion of a heterogeneous media server configuration under evaluation (e.g., is combined with other servers of a different configuration, such as configuration 2 described below with FIG. 7B), the portion of the expected workload dispatched to the configuration 1 portion of the heterogeneous media server cluster (according to a specified load-balancing strategy) is supported by such configuration 1 in the manner reflected by the service demand profile 701A.

In the example of FIG. 7B, service demand profile 701B is also a list of pairs, wherein the first element of each pair represents a time duration (e.g. 150 seconds in the first pair of example service demand profile 701B). The second element of each pair reflects the service demand (or resource “cost”) computed by capacity planner 101 for the corresponding time duration for a media server configuration under consideration (such as media server “configuration 2” in the example of FIG. 7B). In the example service demand profile 701B, the first pair has a service demand of 5.2 for 150 seconds, the second pair provides that a service demand 4.8 was encountered for 900 seconds, and so on. A service demand greater than 1 (e.g., 5.2 for the first pair of service demand profile 901B) means that more than 1 of the server configurations under consideration were required for supporting the workload for a corresponding amount of time (e.g., at least 5.2 of the “configuration 2” servers are needed for supporting 150 seconds of the received workload 203 in the example of the first pair of the service demand profile 701B of FIG. 7B). In other words, the server configuration under consideration was overloaded for the corresponding period of time for which the capacity planner computes that the service demand in supporting workload 203 is greater than 1. Thus, if the configuration 2 is a portion of a heterogeneous media server configuration under evaluation (e.g., is combined with other servers of a different configuration, such as configuration 1 described above with FIG. 7A), the portion of the expected workload dispatched to the configuration 2 portion of the heterogeneous media server cluster (according to a specified load-balancing strategy) is supported by such configuration 2 in the manner reflected by the service demand profile 701B.

The service demand profile for a given configuration type may be ordered by the service demand information (i.e., the second element of the pairs in the example of FIGS. 7A-7B) from greatest service demand to least service demand. In this case, the top pairs in the service demand profile represent the peak load demands for the considered media server configuration under the received workload 203, as well as the corresponding time duration for these peak loads over time. Since workload measurements of existing media services indicate that client demands are highly variable (the “peak-to-mean” ratio may be an order of magnitude), it might not be economical to over-provision the future system using the past “peak” demand. That is, a media server configuration that fails to support the workload for a relatively small period of time (e.g., during “peak” demands or “bursts” of client accesses) may still be a suitable and/or most cost-effective configuration for a service provider to implement. As described above, a service provider can specify service parameters 104, such as SLAs 104A and/or constraints 104B, which may be used by capacity planner 101 in evaluating the service demand profiles 701A, 701B to determine whether the media server configuration under consideration is capable of supporting the expected workload in accordance with the specified service parameters 104. For example, an SLA 104A may be defined by a service provider to specify that a server configuration is desired that is capable of supporting the expected workload at least 99% of the time. Using the computed service demand profiles 701A, 701B, the capacity planner 101 may determine the maximum load requirements corresponding to the 99-th percentile of all the service demands for the heterogeneous media server configuration under consideration over time (under the expected workload). This service demand is denoted herein as Demand_{SLA}.

Additionally, in some instances, a service provider may wish to obtain a media server configuration with planned “spare” capacity for future growth, such as may be specified as constraints 104B For instance, constraints 104B may specify that a media server configuration is desired that is utilized under 70% of its available capacity for at least 90% of the time in supporting the workload 203. Thus, using the computed service demand profiles 701A, 701B, the capacity planner finds the maximum load requirements corresponding to the 90-th percentile of all the service demands for the heterogeneous media server configuration under consideration over time (under the expected workload 203). For example, if the service demand corresponding to 90-th percentile is 3.5, then the requirements to configuration utilized under 70% of its available capacity will be 3.5/0.7=5 (i.e., 5 nodes of the server configuration under consideration should be used to form a clustered media server that satisfies this service demand). This service demand is denoted herein as Demand_{constraints}. Such constraints may be specified/evaluated for each type of server configuration included in a heterogeneous cluster (e.g., each type of server configuration included in the heterogeneous cluster, which may include a plurality of nodes of such configuration type, is to be used under 70% of its available capacity for at least 90% of the time), or the constraints may be specified/evaluated for the overall heterogeneous cluster in which servers of certain configuration types may not comply with the constraints but the heterogeneous cluster taken as a whole does.

In this example, capacity planner 101 may determine a desirable performance requirement as Demandₒᵥₑᵣₐₗₗ=max(Demand_{SLA}, Demand_{Constraints}) rounded up to the closest integer. Such Demandₒᵥₑᵣₐₗₗ may be computed for each server configuration type included in a heterogeneous cluster. In some instances, there may be multiple media server configurations satisfying the specified performance requirements. Taking into consideration the monetary price information of the corresponding configurations, the best cost/performance solution can be determined by capacity planner 101. The Demand_{SLA}, Demand_{constraints}, and Demandₒᵥₑᵣₐₗₗ may be determined for each type of server configuration included in a heterogeneous media server cluster under evaluation.

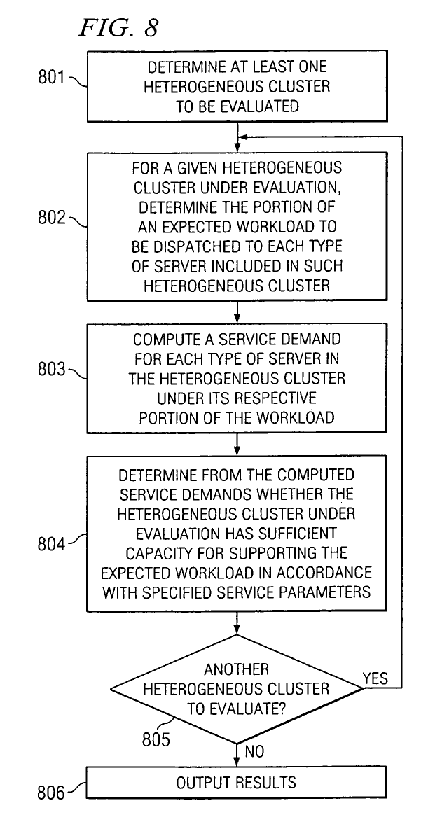

FIG. 8 shows an operational flow diagram for certain embodiments of a capacity planning tool that is operable to evaluate capacity of a heterogeneous cluster. In operational block 801 at least one heterogeneous cluster to be evaluated is determined. That is, a combination of different types of server configurations arranged in a cluster is determined. As described further herein, such heterogeneous cluster(s) to be evaluated may be determined in a number of different ways. For instance, a user may input specific heterogeneous cluster(s) to be evaluated. That is, a user may specify a specific combination of different types of server configurations (e.g., 5 nodes of server type S₁, 8 nodes of server type S₂, etc.) to form the heterogeneous cluster to be evaluated.

As another example, the user may specify a finite number of each of a plurality of different types of servers that are available for use in forming a heterogeneous cluster, and the capacity planning tool may determine various combinations of such available servers and evaluate the capacity of each combination to determine those combination(s), if any, that support the expected workload in a desired manner (e.g., in accordance with specified service parameters). For instance, a user may specify that 10 nodes of server type S₁, 15 nodes of server type S₂, and 7 nodes of server type S₃ are available for use in forming a clustered media server solution, and the capacity planning tool determines various combinations of such available servers to evaluate.

As still another example, a finite number of each server configuration type may not be supplied by a user, but instead an upper limit of the number of each server configuration type that may be required is determined by the capacity planning tool by determining a homogeneous solution for each server configuration type. For instance, a determination can be made as to the number of S₁ servers to be included in a homogeneous clustered media server for supporting the expected workload in a desired manner, the number of S₂ servers to be included in a homogeneous clustered media server for supporting the expected workload in a desired manner, and the number of S₃ servers to be included in a homogeneous clustered media server for supporting the expected workload in a desired manner. The determined homogeneous solution for each server type provides an upper bound of the number nodes of each server type that may be required for supporting the expected workload in a desired manner. Various heterogeneous clusters may be determined using combinations of the number of nodes of each type up to their respective upper bounds. For example, a first heterogeneous mix of such servers S₁, S₂, and s₃ that is capable of supporting the expected workload in a desired manner may be formed having the number of each server type of its respective homogeneous solution, and this heterogeneous mix may be gradually reduced to determine a various other heterogeneous clusters to be evaluated.

As yet another example, a service provider may specify an existing cluster of nodes of at least a first type (e.g., 10 nodes of server S₁) that the service provider has, and the service provider may identify various additional server types to be considered for being added to the existing cluster. For instance, suppose the service provider has an existing cluster of 10 nodes of server S₁ and desires to increase the capacity of this cluster by adding to this cluster additional servers of types S₁, S₂, and/or S₃. Various heterogeneous clusters may be determined by the capacity planning tool (e.g., by gradually adding servers of types S₂ and/or S₃ to the existing cluster).

Any other technique for determining at least one heterogeneous cluster to be evaluated that is now known or later discovered may be employed with the embodiments of the capacity planning tool described herein. In operational block 802, for a given heterogeneous cluster under evaluation, the portion of an expected workload to be dispatched to each type of server included in the heterogeneous cluster is determined. As described further herein, in certain embodiments, a weighted load balancing strategy (e.g., weighted round-robin) may be determined and such strategy used for determining how the requests of the expected workload would be allocated among the various nodes of the heterogeneous cluster. As also described herein, in certain embodiments, the portion of the expected workload allocated to each type of server in the heterogeneous cluster is used (by MediaProf 202) to generate a workload profile for each server type (such as workload profiles 203 described above with FIGS. 3 and 4).

In operational block 803, the capacity planner computes a service Demand for each type of server in the heterogeneous cluster under evaluation based on the respective portion of the expected workload allocated to each server type. For instance, if the heterogeneous cluster under evaluation has 5 servers of type A and 7 servers of type B, a service Demand is computed for the type A servers and a service Demand is computed for the type B servers. As described above, with FIGS. 7A and 7B, in certain embodiments, the workload profile of each type of server configuration is processed to determine a service demand profile, which can be used to determine if the server configuration complies with the service parameters 104 specified by a service provider. As described further herein, the computed service Demand identifies the number of servers of the corresponding configuration type that are needed to support its allocated portion of the workload in a desired manner (e.g., in accordance with the service parameters 104).

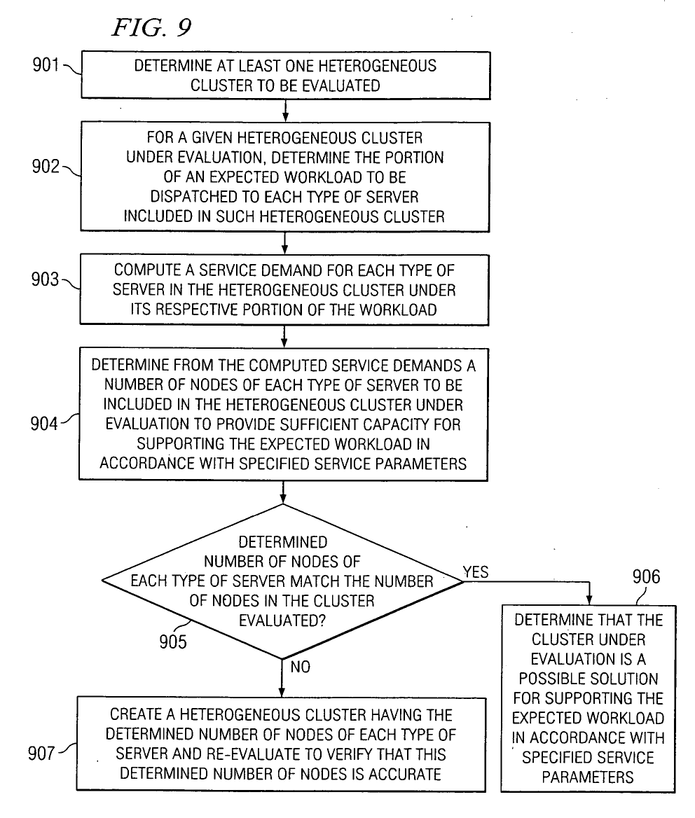

In operational block 804, the capacity planner determines from the computed service Demands whether the heterogeneous cluster under evaluation has sufficient capacity for supporting the expected workload in accordance with specified service parameters. In certain implementations, such as the example operational flow of FIG. 9 below, if the heterogeneous cluster under evaluation is determined as not having sufficient capacity for supporting the expected workload, the computed service Demands are used to determine a heterogeneous cluster of the server configuration types under evaluation that does have sufficient capacity for supporting the expected workload in accordance with the specified service parameters 104.

In operational block 805, the capacity planning tool determines whether it is to evaluate another heterogeneous cluster, and if so, then operation returns to block 802 to repeat operations 802, 803, and 804 for the next heterogeneous cluster to be evaluated. Otherwise, the capacity planning tool may output its results (e.g., indication, for each heterogeneous cluster evaluated, whether such heterogeneous cluster has sufficient capacity for supporting the expected workload) in block 806.

Turning to FIG. 9, another example operational flow diagram for certain embodiments of a capacity planning tool is shown. Again, at least one heterogeneous cluster to be evaluated is determined in block 901. As described above, such heterogeneous cluster(s) to be evaluated may be determined in a number of different ways. As with operational block 802 described above with FIG. 8, in operational block 902, for a given heterogeneous cluster under evaluation, the portion of an expected workload to be dispatched to each type of server included in the heterogeneous cluster is determined. Also, as with operational block 803 described above with FIG. 8, the capacity planner computes, in block 903, a service Demand for each type of server in the heterogeneous cluster under evaluation based on the respective portion of the expected workload allocated to each server type.

In operational block 904, the capacity planner determines from the computed service Demands the number of servers (nodes) of each configuration type that are needed to support its allocated portion of the workload in a desired manner (e.g., in accordance with the service parameters 104). In operational block 905, the capacity planner determines whether the number of nodes determined in block 904 for each type of server configuration match the number of nodes of each type of server configuration included in the heterogeneous cluster under evaluation. If the number of nodes determined in block 904 for each type of server configuration match the number of nodes of each type of server included in the heterogeneous cluster under evaluation, then the cluster under evaluation is determined, in block 906, as a possible solution that is capable of supporting the expected workload in accordance with the specified service parameters 104.

On the other hand, if the number of servers of at least one type of server configuration determined in block 904 do not match the number of servers of the corresponding type of server configuration included in the heterogeneous cluster under evaluation, then, in operational block 907, a new heterogeneous cluster having the determined number of nodes (from block 904) of each server configuration type is created and the new heterogeneous cluster is evaluated to verify that it has sufficient capacity for supporting the expected workload as desired. For instance, suppose the heterogeneous cluster under evaluation includes a single server of configuration type “A” therein, and suppose that when evaluating the capacity of this single server configuration type A the capacity planner determines its Demand=4.5 (indicating that a cluster of 5 nodes of such server configuration type A is needed for supporting its allocated portion of the expected workload). In this instance, the capacity planner may re-evaluate the capacity of the heterogeneous clustered media server to include the resources (e.g., amount of memory, etc.) of 5 of the servers of the configuration type A. For instance, the capacity planner may again determine the proper weighted load balancing strategy to employ and the media site workload profile(s) 203 for such a heterogeneous clustered media server (because the workload profile(s) 203 for the clustered media server may differ from the workload profile(s) 203 initially determined for the cluster that included a single server of configuration type A, and capacity planner uses such determined workload profile(s) for this new heterogeneous media cluster (that includes 5 nodes of configuration type A) to re-compute the Demand for each configuration type. The computed Demand for each configuration type is again evaluated (as in block 905) to determine if it matches the number of servers of each configuration type in the heterogeneous cluster under evaluation. The above iterative process may be repeated until a proper number of servers of each configuration type to be included in the heterogeneous cluster is determined.

In certain embodiments, the capacity planner may determine a solution for each possible combination of types of servers under consideration. For instance, Table 1 below shows an example of all possible combinations of types of servers S₁, S₂, and S₃ that may be implemented in a clustered solution, where a “1” in the table represents that at least one node of the corresponding type of server is present in the cluster and a “0” in the table represents that no node of the corresponding type of server is present in the cluster. Thus, a homogeneous clustered solution for each of the three types of servers may be determined, and various heterogeneous solutions may also be determined. Thereafter, the capacity planning tool and/or the service provider may compare the cost, capacity, etc. of each solution to determine the optimal solution for the service provider to implement for supporting his expected workload.

TABLE 1
Combinations of Servers S₁, S₂, S₃ that may be implemented in a clustered
media server solution.

| S₁ | S₂ | S₃ |
|---|---|---|
| 1 | 0 | 0 |
| 0 | 1 | 0 |
| 0 | 0 | 1 |
| 1 | 1 | 0 |
| 1 | 0 | 1 |
| 0 | 1 | 1 |
| 1 | 1 | 1 |

Turning to FIG. 10A, one embodiment of a capacity planning system 1000 is shown. This example embodiment is described hereafter with an example scenario in which a service provider has the following collection of servers:
N₁ servers of type S₁;
N₂ servers of type S₂; and
N₃ servers of type S₃.
   Thus, in this example, a finite number of each of the server configuration types is known which are available for use in forming a clustered media server solution. And, the problem is to design the performance satisfactory and price efficient solution out of these heterogeneous components (such that the proposed solution may have servers of different types S₁, S₂, and S₃ combined in the cluster for supporting the expected media workload). Of course, this embodiment of the capacity planning system is not limited in application to such a scenario, but may instead be used for evaluating any number of different types of server configurations that may be combined for forming a heterogeneous media server solution. Thus, while the above example collection of servers of types S₁, S₂, and S₃ are used in the below description, application of the capacity planning system is not limited to such an example collection, but may instead be used in evaluating any number of different types of servers.

In this example embodiment, workload information 201 (e.g., the collected media server access logs for a service provider's site) is input to MediaProf 202 (via dispatcher 1001 in this example). MediaProf 202 generates Media site workload profiles 203 for each media server configuration under consideration, as described above. Thus, using the workload information 201 (e.g., collected media server access logs), MediaProf 202 computes a set of media site workload profiles 203 for different memory sizes of interest. The generated workload profiles 203 are input to capacity planner 101. Additionally, service parameters such as SLAs 104A and constraints 104B are input to capacity planner 101. Using a collection of benchmarked configurations 204, as well as the received workload profiles 203, SLAs 104A, and constraints 104B, capacity planner 101 computes, in block 1002, a service Demand for each of the media server configurations under consideration in the manner described above.

For instance, for evaluating a first server configuration (e.g., the one of the server configuration types S₁, S₂, and S₃ that is the most powerful or has the largest memory), capacity planner uses the corresponding benchmarks 204 (e.g., SFB and UFB) for such configuration along with the corresponding workload profile 203 (e.g., MP₁) for such configuration in computing the service Demand for that configuration in block 1002. From the computed service Demand for this first server configuration, capacity planner 101 determines whether a single one of such first server configuration can support the workload in a desired manner (e.g., in a manner that complies with SLAs 104A and constraints 104B). If determined that a single one of such first server configuration can support the workload in a desired manner, capacity planner identifies that such a media server configuration is suitable for supporting the workload in block 1003.

However, if capacity planner 101 determines from the computed service Demand that a single one of the first server configuration under consideration is not capable of supporting the workload in the desired manner, capacity planner identifies in block 1004 that a cluster is needed. An initial determination of the number of nodes (i.e., the number of such first server configurations) to be included in the clustered media server solution is made from the computed service Demand. For example, if the computed service Demand for this first server configuration is 5 (or any number between 4 and 5, such as 4.5), then capacity planner 101 can initially determine that a cluster having 5 nodes of this first configuration is suitable for supporting the workload in the desired manner.

Of course, the initial computation of the service Demand was made using the workload profile 203 generated for a single one of the first server configuration. Thus, while the initial computation of the service Demand is reliable for indicating whether a single one of the first server configuration is capable of supporting the workload or whether a cluster of additional servers is needed, if the service Demand indicates that a cluster is needed, the specific number of nodes initially indicated by such service Demand (e.g., 5) may be less reliable because such number is estimated through an evaluation of the resources of a single one of the first server configuration (rather than an actual evaluation of the resources of a cluster having the estimated number of nodes and the type of load balancing strategy employed for such cluster). Accordingly, to verify that the initial indication of 5 nodes, in the above example, is accurate, capacity planner 101 may re-compute the service Demand taking into consideration the resources and load balancing strategy of a cluster of the initially indicated nodes (up to the maximum number of such nodes available to the service provider).

If the determined number of nodes of the first configuration to be included in a homogeneous solution is greater than the finite number of nodes of such first configuration that are available to the service provider, then a heterogeneous solution that includes ones of the available nodes of other types is evaluated. For instance, suppose the computed service Demand determines that 5 nodes of the server configuration S₁ are needed for supporting the expected workload in the desired manner, and further suppose that only 2 nodes of server configuration S₁ are available to the service provider (i.e., N₁=2 in the above example); in this case, the remaining demand beyond what can be supported by the 2 available nodes of server configuration S₁ is to be supported by a server configuration of a different type (e.g., by one or more nodes of configurations S₂ and S₃).

Accordingly, if the Demand determined for the homogeneous case of the first server configuration S₁ exceeds the number of such servers of configuration S₁ that are available (i.e., the determined number of S₁ servers needed in a homogeneous solution exceeds the number N₁ of such S₁ servers that are available), then a second configuration types is considered in combination with the first configuration type. For instance, additional servers of the second configuration S₂ (e.g., the second most powerful or second largest memory configuration) may be added to the N₁ servers of the first type S₁ to form a heterogeneous cluster. Combinations of nodes of the S₁ and S₂ servers may be evaluated to determine whether the available servers of types S₁ and S₂ are capable of supporting the expected workload as desired. If determined that the N₁ servers of type S₁ and the N₂ servers of type S₂ are insufficient for supporting the expected workload as desired, then the third type of server my be included in the heterogeneous cluster. For instance, additional servers of the third configuration S₃ (e.g., the third most powerful or third largest memory configuration) may be added to the N₁ servers of the first type S₁ and the N₂ servers of the second type S₁ to form a heterogeneous cluster. Combinations of nodes of the S₁, S₂, and S₃ servers may be evaluated to determine whether the available servers of these types are capable of supporting the expected workload as desired. That is, additional servers of type S₃, up to the available N₃ number of such servers, may be progressively added to the combination of N₁ servers of type S₁ and the N₂ servers of type S₂ to determine whether a heterogeneous solution can be obtained having sufficient capacity for supporting the expected workload as desired.

It should be noted that when evaluating a heterogeneous cluster that includes nodes of each of the three different types of servers: S₁, S₂, and S₃, three different service demand profiles are built by block 1002 where the first service demand profile is built for a server type S₁, the second service demand profile is built for a server type S₂, and the third service demand profile is built for a server type S₃. More particularly, dispatcher 1001 specifies the portion of workload 201 to be dispatched to each of the three different types of servers in accordance with a specified load-balancing strategy (e.g., weighted round-robin, etc.), and MediProf 202 generates a workload profile 203 for each of the three different types of servers. Capacity planner 101 receives the workload profiles 203 and, in block 1002, uses the benchmarks 204 for each server configuration S₁, S₂, and S₃ to compute a service Demand for each respective server configuration.

As illustrated in the example of FIG. 10A, capacity planner 10 evaluates the load balancing strategy(ies) for the initially determined number of nodes (as indicated by the service Demand) in block 1005. The resources of such cluster of nodes and the load balancing strategy(ies) are taken into account in generating a new workload profile 203. For instance, dispatcher 1001 inputs identification of the resources of such a clustered media server, as well as identification of the load balancing strategy to be utilized by the cluster, into MediaProf 202, which generates the new workload profile 203 for such cluster. Thus, for example, if dispatcher 1001 initially dispatches requests of workload 201 to a cluster having one of each of the three types of servers S₁, S₂, and S₃ in accordance with a specified load-balancing strategy, which results in a workload profile 203 generated by MediaProf 202 for each of the three types of servers. Based on analysis in block 1002 by capacity planner 101 of the workload profile 203, a service Demand is determined for each of the types of servers, which may specify, for example, that 2 nodes of server type S₁ are needed to support the portion of the workload dispatched to such server type S₁, 2 nodes of server type S₂ are needed to support the portion of the workload dispatched to such server type S₂, and 1 node of server type S₃ are needed to support the portion of the workload dispatched to such server type S₃.

Once an initial determination is made regarding how many servers of each type to include in the clustered media server solution, the resources of such cluster of nodes and the load balancing strategy(ies) are taken into account in generating a new workload profile(s) 203. For instance, dispatcher 1001 inputs identification of the resources of such a clustered media server (e.g., 2 nodes of server type S₁, 2 nodes of server type S₂, and 1 node of server type S₃ in this example), as well as identification of the load balancing strategy to be utilized by the cluster, into MediaProf 202, which generates the new workload profile 203 for each of the server types of such cluster. As described further below, a new weighted load balancing strategy (e.g., weighted round-robin) that allocates weights in a manner that accounts for all of the nodes in this new cluster may also be determined.

Turning to FIG. 10B, an example of re-generating workload profiles 203 for a cluster of servers of various configuration types S₁, S₂, and S₃ in accordance with one embodiment is shown. In this example, capacity planner 101 determines (e.g., from the service Demand computed for the portion of the workload 201 that is dispatched to server S₁ that a cluster of 2 nodes of such server configuration S₁ are required for supporting this portion of the expected workload as desired (e.g., in compliance with SLAs 104A and Constraints 104B). Further, capacity planner 101 determines (e.g., from the service Demand computed for the respective portions of the workload 201 dispatched to servers S₂ and 53 that a cluster of 2 nodes of such server configuration S₂ and 1 node of server configuration S₃ are required for supporting their respective portions of the expected workload as desired (e.g., in compliance with SLAs 104A and Constraints 104B). Capacity planner 101 notifies dispatcher 1001 of a cluster of 2 nodes of server type S₁, 2 nodes of server type S₂, and 1 node of server type S₃. In this example, capacity planner 101 also notifies dispatcher 1001 of a load balancing strategy “X” (e.g., weighted round-robin) that is to be used by the cluster. Of course, such load balancing strategy may be provided to dispatcher 1001 in some other way in alternative embodiments, such as through user input, dispatcher 1001 reading the desired load balancing strategy to be used from a data storage device, etc. Additionally, a plurality of different load balancing strategies may be evaluated in certain embodiments. For instance, dispatcher 1001 may use a first load balancing strategy to generate subtraces (as described further below), which are used by media profiler 202 to generate workload profiles 203 for the cluster when using the first load balancing strategy, and dispatcher 1001 may use a second load balancing strategy to generate subtraces (as described further below), which are used by media profiler 202 to generate a workload profiles 203 for the cluster when using this second load balancing strategy; and capacity planner 101 may compute the respective service Demand for each of the workload profiles.

Dispatcher 1001 uses the load balancing strategy (e.g., strategy X in the example of FIG. 10B, such as a weighted round-robin strategy) to generate subtraces (which may be referred to herein as “sub-workloads”) for workload 201. That is, dispatcher 1001 divides workload 201 into 5 subtraces, Subtrace₁, Subtrace₂, . . . , Subtrace₅, wherein each subtrace identifies the portion of workload 201 (i.e., the corresponding requests) that is to be serviced by a corresponding one of the 5 nodes of the media server configuration according to the load balancing strategy X employed by the cluster under consideration. For instance, in the example of FIG. 10B, Subtrace₁ is generated for Node₁ of server configuration S₁, Subtrace₂ is generated for Node₂ of server configuration S₁, Subtrace₃ is generated for Node₃ of server configuration S₂, Subtrace₄ is generated for Node₄ of server configuration S₂, and Subtraces is generated for Node₅ of server configuration S₃. Each of the resulting subtraces are input to MediaProf 202, which processes each subtrace for its corresponding node to determine the access types of each request (memory versus disk). For instance, in the example embodiment of FIG. 10B, in operational block 1002₁ MediaProf 202 runs the memory model (for server configuration S₁) to determine the access type for each request in Subtrace₁ being serviced by Node₁. Similarly, in operational block 1002₂ MediaProf 202 runs the memory model (for server Configuration S₁) to determine the access type for each request in Subtrace₂ being serviced by Node₂. Likewise, in operational blocks 1002₃₋₄ MediaProf 202 runs the memory model (for server Configuration S₂) to determine the access type for each request in the respective Subtraces₃₄ being serviced by their corresponding Nodes₃₋₄, and in operation block 1002₅ MediaProf 202 runs the memory model (for server Configuration S₃) to determine the access type for each request in Subtrace₅ being serviced by Node₅.

Thus, a sub-workload (or subtrace) profile is generated for each of Subtraces₁₋₅. Then, the sub-workload profiles for each server type included in the cluster are merged using the time stamps of the individual sub-workloads. That is, the sub-workload profiles for like server types are merged together, which results in a sub-workload profile for each of the server types S₁, S₂, and S₃ included in the cluster under evaluation. In the specific example of FIG. 10B, in operational block 1003₁, MediaProf 202 merges the results determined in operations 1002₁₋₂ according to timestamp to generate a workload profile 203, for the servers of configuration type S₁ of the cluster. Similarly, in operational block 1003₂, MediaProf 202 merges the results determined in operations 1002₃₋₄ according to timestamp to generate a workload profile 203₂ for the servers of configuration type S₂ of the cluster. In this example, only one server of configuration S₃ is included in the cluster under evaluation, and thus no merging operation is performed for that server. Accordingly, the sub-workload profile determined in block 1002₅ is output as workload profile 203₃ for the server of configuration type S₃ of the cluster.

Accordingly, the newly generated workload profiles 203₁₋₃ for the heterogeneous cluster under consideration identifies the number of concurrent requests serviced by each type of server included in the cluster at any given time, as well as an indication of the respective type of access for each request (memory versus disk). Therefore, the benchmarks and cost function for each server configuration type included in the cluster (types S₁, S₂, and S₃ in this example) can be used by capacity planner 101 to re-compute the service Demand for each server configuration type in this cluster based on their respective workload profile 203₁₋₃.

For instance, as shown in FIG. 10A, capacity planner 101 then uses the workload profiles 203 generated for the cluster under consideration to compute, in block 1002, a service Demand for each type of servers included in such cluster. This is used to verify that the initially determined number of nodes of each server type to be included in the cluster is accurate. For instance, continuing with the above example, capacity planner 101 uses the workload profile 203, for the servers of type S₁ and the information 204 for such configuration S₁ to re-compute the service Demand for such S₁ servers included in the cluster under evaluation to verify that the computed service Demand indicates that 2 nodes of such server configuration S₁ are needed in the cluster for supporting the workload in the desired manner. If the service Demand re-computed for each of the server types confirms the same number as initially determined (e.g., that 2 nodes of each of servers S₁ are needed and 1 node of server S₃ is needed), capacity planner 101 outputs such heterogeneous cluster as one possible solution. On the other hand, if the service Demand computed for one or more of the types of servers indicates a different number of nodes, such as 1 node of server S₁, then capacity planner 101 repeats the above process for a cluster having the adjusted number of nodes (e.g., 1 node of server S₁, along with the indicated correct number of nodes for types S₂ and S₃) in order to verify this estimate of 4 heterogeneous nodes.

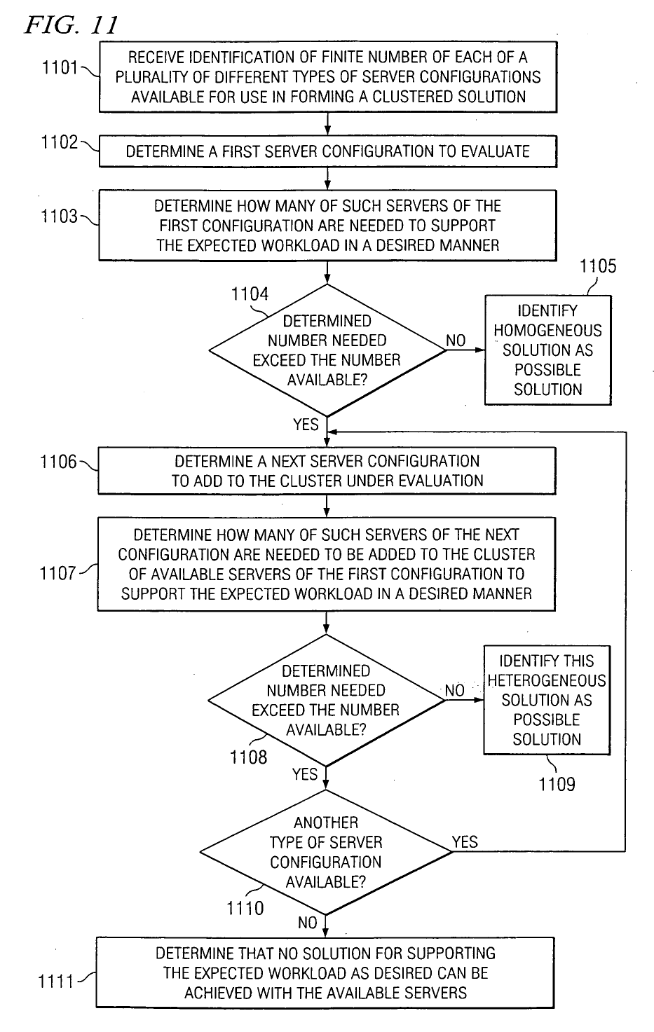

Turning to FIG. 11, an example operational flow diagram of one implementation of the embodiment of FIGS. 10A-10B is shown. In operational block 1101, the capacity planning tool receives identification of a finite number of each of a plurality of different types of server configurations available for use in forming a clustered solution. For instance, in the above example discussed with FIGS. 10A-10B the following collection of servers is received:
N₁ servers of type S₁;
N₂ servers of type S₂; and
N₃ servers of type S₃.

In operational block 1102, the capacity planning tool determines a first server configuration to evaluate. The server configuration to evaluate may be determined as the most powerful one, the one with the largest memory, the most expensive one, the least expensive one, or may be selected in any other manner. The above-described evaluation process is conducted to determine, in operational block 1103, how many servers of this first configuration type are needed to support the expected workload in a desired manner. In block 1104, the capacity planning tool determines whether the number of servers of the first configuration type needed for supporting the expected workload exceeds the number of servers of such first configuration type that is available. If not, then the capacity planning tool identifies the homogeneous solution (of the determined number of servers of the first configuration type from block 1103) as a possible solution for the service provider.

If the determined number of servers of the first configuration type needed for supporting the expected workload exceeds the number of servers of such first configuration type that is available, then a next server configuration to add to the cluster under evaluation is determined in block 1106. As with the first server configuration selected, this next configuration to be included may be selected on any desired basis, such as the next most powerful one, the one with the next largest memory, the next most expensive one, the next least expensive one, etc. The above-described evaluation process is conducted again to determine, in operational block 1107, how many servers of this second configuration type are needed to be added to the available servers of the first configuration type in order to support the expected workload in a desired manner. In block 1108, the capacity planning tool determines whether the number of servers of the second configuration type needed to be added to the available number of servers of the first configuration type for supporting the expected workload exceeds the number of servers of such second configuration type that is available. If not, then the capacity planning tool identifies the heterogeneous solution (of the determined number of servers of the second configuration type with the available number of servers of the first configuration type from block 1107) as a possible solution for the service provider.

If the determined number of servers of the second configuration type needed to be added to the available servers of the first configuration type for supporting the expected workload exceeds the number of servers of such second configuration type that is available, then operation advances to block 1110. In block 1110, the capacity planning tool determines whether another type of server configuration that has not yet been included in the cluster under evaluation is available. If so, then operation returns to block 1106 to determine a next server configuration to add to the cluster under evaluation (e.g., to add to the available servers of the first and second configuration types). If determined in block 1110 that no further servers are available, then the capacity planning tool determines in block 1111 that no solution for supporting the expected workload as desired can be achieved with the available servers.

As described hereafter, in certain embodiments, a proper weighted load balancing strategy, such as a weighted round-robin strategy, is determined by the capacity planning tool for a heterogeneous cluster under evaluation. Media server clusters are used to create scalable and highly available solutions. We assume in this example that each media server in a cluster has access to all the media content. Therefore, any server can satisfy any client request.

A load balancing solution for a homogeneous media server cluster (i.e. a cluster having nodes of all the same configuration type), such as Round-Robin (RR), tries to distribute the requests uniformly to all the machines. However, when the cluster is comprised of heterogeneous machines (some of the servers have a higher capacity than the other ones in the cluster) it may be preferable to use a Weighted Round Robin (WRR) load balancing solution. Of course, any load balancing strategy desired to be employed may be evaluated by capacity planner 101 using the techniques described herein. In certain embodiments, capacity planner 101 is capable of determining an optimal WRR load balancing solution to implement for a given heterogeneous media server solution. Thus, the capacity planner 101, in certain embodiments, outputs not only one or more heterogeneous media server configurations, but also outputs for each heterogeneous media server configuration the optimal WRR load balancing solution to employ for such configuration in order to support the expected workload in the desired manner (e.g., in accordance with the SLAs 104A and constraints 104B).

A WRR load balancing solution allows a performance weight to be assigned to each server in a cluster. Weighted load balancing is similar to the round-robin technique, however, servers with a higher weight value receive a larger percentage of requests at any one time. WRR administrators can assign a weight to each server of a clustered media server configuration, and the WRR uses this weight to determine the percentage of the current number of connections to give each server.

Weighting-value is the value to use in the cluster load balancing algorithm. The range can be from 1 to 100, in this example implementation, but can of course be any range of weighting values desired to be used in other WRR implementations. For example, in a configuration with five media servers, the percentage of requests may be defined as follows:

| | |
|---|---|
| Weight of server 1: | 7 |
| Weight of server 2: | 8 |
| Weight of server 3: | 2 |
| Weight of server 4: | 2 |
| Weight of server 5: | 5 |
| Total weight of all servers | 24. |

This distribution results in server 1 getting 7/24 of the current number of requests, server 2 getting 8/24, server 3 getting 2/24, and so on. If a new server, server 6, is added with a weight of 10, it will receive 10/34 of the requests distributed thereto, and so on.

In one example embodiment of the capacity planning tool, a heterogeneous cluster sizing with a corresponding WRR load balancing solution is determined and output. Let the outcome of the first iteration of Capacity Planner 101 for the original media site expected workload 201 and the media server S₁ (i=1, 2, 3) be the capacity requirement of Nᵢ^{all} servers. Let also Nᵢ<Nᵢ^{all}. Otherwise, the service provider can use a homogeneous cluster solution. We assume, in this discussion, that due to the lack of nodes of any particular type, the service provider has to design a heterogeneous media cluster solution out of the existing variety of different server configurations.

Let N₁^{all}≦N₂^{all}≦N₃^{all}. Thus, server S₃ had the smallest capacity and requires a highest number of nodes to support the given media workload 201 (the full workload), while media server S₁ had the largest capacity and requires the smallest number of nodes for the same traffic. Now, we can express the capacity of server S₁ via the capacity of servers S₂ and S₃. Similarly, we can express the capacity of server S₂ via the capacity of server S₃:

$$\begin{matrix}{S}_{1} = \frac{{N}_{3}^{all}}{{N}_{1}^{all}} \times {S}_{3} \\ {S}_{2} = \frac{{N}_{3}^{all}}{{N}_{2}^{all}} \times {S}_{3}\end{matrix}$$

Additionally, the above equations help to compute the weights for the corresponding servers in the cluster when using a WRR load balancing solution: for a single request sent to a server of type S₃, there should be

$$\frac{{N}_{3}^{all}}{{N}_{1}^{all}}$$

requests sent to a server of type S₁, and

$$\frac{{N}_{3}^{all}}{{N}_{2}^{all}}$$

requests sent to a server of type S₂. This is similar to setting up the weights in WRR as follows:

$$\begin{matrix}Weight of server {S}_{1} \text{:} & \frac{{N}_{3}^{all}}{{N}_{1}^{all}} \\ Weight of server {S}_{2} \text{:} & \frac{{N}_{3}^{all}}{{N}_{2}^{all}} \\ Weight of server {S}_{3} \text{:} & 1\end{matrix}$$

Since weights are reflected as integers in this example implementation, the closest integer numbers reflecting similar weights are determined: in particular, each weight can be multiplied by N₁^{all}×N₂^{all} to get the integer expression:
Weight of server S₁ N₃^{all}×N₂^{all}
Weight of Server S₂ N₃^{all}×N₁^{all}
Weight of server S₃ N₁^{all}×N₂^{all}

After that, the capacity planning tool finds all the feasible combinations of different servers of S₁, S₂ and S₃ that can support the given traffic (as a result of the first iteration). In accordance with one embodiment, these combinations can be determined in the following way. A given workload requires N₁^{all} servers of type S₁. However, the service provider only has N₁ servers of type S₁. Thus after including N₁ servers of type S₁ in the solution, the additional capacity (N₂^{all}−N₁)×S₁, has to be composed out of servers S₂ and/or S₃. Note that

$${S}_{1} = \frac{{N}_{2}^{all}}{{N}_{1}^{all}} \times {S}_{2} .$$

Thus we can compute how many additional servers S₂ is required to be added in order to support a given traffic (with just servers S₁ and S₂):

$${k}_{2} = ( {N}_{1}^{all} - {N}_{1} ) \times \frac{{N}_{2}^{all}}{{N}_{1}^{all}} ,$$

where k₂ is rounded up to the closest integer.

If k₂≦N₂ then the combination of N₁ servers of type S₁ and k₂ servers of type S₂ will be a possible combination for a given traffic. If k₂>N₂, then after including N₁ servers of type S₁ and N₂ servers of type S₂ in the solution, the additional remaining capacity has to be composed out of servers S₃. The procedure is similar to that described above.

Suppose the remaining traffic requires k₃ servers of type S₃. If k₃≦N₃ then we have a feasible solution which has N₁ servers of type S₁, N₂ servers of type S₂, and k₃ servers of type S₃. Otherwise, if the existing collection of servers (N₁ of S₁, N₂ of S₂, N₃ of S₃) is not sufficient to support a given traffic, then the service provider may need to add the sufficient number of the “cheapest” server type to get the desirable cluster configuration.

In a similar way, another appropriate solution comprised of n₁ servers of type S₁, n₂ servers of type S₂, and n₃ servers of type S₃ can be designed, where n₁≦N₁, n₂≦N₂, and n₃≦N₃. The capacity planning tool can perform an exhaustive search of all possible combinations. In the designed heterogeneous cluster, the WRR load balancing solution uses the server weights that are computed as described above.

Thus, let us consider the solution identified during the first iteration having n₁ servers of type S₁, n₂ servers of type S₂ and n₃ servers of type S₃, where n≦N₁, n₂≦N₂, and n₃≦N₃. In one example embodiment, then the capacity planner tool performs the following sequence of steps to re-evaluate the identified cluster solution:
A) partition the original media site workload W (workload 201 of FIG. 10A) into k=n+n₂+n₃ sub-workloads W₁, W₂, . . . , Wₖ using dispatcher 1001 employing the corresponding WRR load balancing strategy;
B) compute the sub-workload profile for each of sub-workloads W₁, W₂, . . . , Wₖ using MediaProf 202;
C) merge the computed sub-workload profiles for the same server type by using the time stamps of individual sub-workloads: i.e., at this point we have the three workload profiles 203—one for each of server types S₁, S₂, S₃;
D) compute the service demand profiles for those three workload profiles 203 by using the corresponding cost functions for each media server type, i.e., Demand D, for a workload that is processed by servers of type S₁, Demand D₂ for a workload that is processed by servers of type S₂, and Demand D₃ for a workload that is processed by servers of type S₃;
E) combine the service demand requirements, the SLAs 104A and the configuration constraints 104B for each of the service demand profiles: D₁ D₂ and D₃;
F) if the outcome of step (E) is still the capacity requirements of n₁ servers of type S₁, n₂ servers of type S₂, and n₃ servers of type S₃, then the cluster sizing is done correctly and the capacity planning process for a considered cluster configuration is completed;
G) if for one of the service demand profile D₁ (of server type S₁) the computed capacity requirements are lᵢ nodes (lᵢ≠nᵢ), then the capacity planning process is repeated for the a new heterogeneous cluster configuration: where the S₁ server type is the “smallest” capacity server that satisfies this requirement;
H) if 1) (lᵢ<nᵢ) or 2) (lᵢ>nᵢ and lᵢ≦Nᵢ) then the whole process is repeated for a new heterogeneous cluster configuration: where the Sᵢ server type has lᵢ nodes;
I) if lᵢ>nᵢ and lᵢ>Nᵢ, then the whole process is repeated for a new heterogeneous cluster configuration: where the Sᵢ server type has Nᵢ nodes (because Sᵢ has lᵢ-=Nᵢ nodes available); and
J) if lᵢ>nᵢ=Nᵢ (i.e. all the nodes of a server type S₁ are exhausted) then let the server type Sⱼ be the closest by capacity to the server type Sᵢ that has available nodes to be added to the cluster solution, and let the server type Sⱼ be with the cheapest cost (we would like to minimize the cost of the overall configuration). Then, the whole process is repeated for a new heterogeneous cluster configuration, where the Sⱼ server type has nⱼ+1 nodes.

While one example technique for determining various heterogeneous clusters to evaluate is provided above in conjunction with FIGS. 10A, 10B, and 11, in which a finite number of each of a plurality of different server configuration types is specified, in certain embodiments, a finite number of nodes of each server type that are available to a service provider may not be known, and instead an upper limit of the number of nodes of each type under consideration may be determined as follows. Suppose, for instance, that the service provider desires to build a solution that may incorporate three different types all of servers S₁, S₂, and S₃. In this case, let N₁^{all} be the number of servers of type S₁ required for support of the expected workload by a configuration that consists only of the S₁ servers; N₂^{all} be the number of servers of type S₂ required for support of the expected workload by the configuration that consists only of the S₂ servers; and N₃^{all} be the number of servers of type S₃ required for support of the expected workload by the configuration that consists only all of the S₃ servers. That is, N₁^{all} is the number of servers of type S₁ required in a homogeneous cluster for supporting of the expected workload in a desired manner, N₂^{all} is the number of servers of type S₂ required in a homogeneous cluster for supporting the expected workload in a desired manner, and N₃^{all} is the number of servers of type S₃ required in a homogeneous cluster for supporting the expected workload in a desired manner. Thus, the homogeneous solutions forms the upper bound for the number of servers of each type that may be required. Of course, when forming a heterogeneous solution, all of the servers of each type required for their respective homogeneous solutions will not be required for supporting the expected workload.

Considering an appropriate WRR load balancing strategy, for example, an optimal heterogeneous solution may be determined by the capacity planner 101 by designing a media server cluster solution having a heterogeneous mix of the servers S₁, S₂, and S₃ and the corresponding load balancing solution. For instance, the capacity planner 101 may form an initial cluster having N₁^{all} servers of type S₁, N₂^{all} servers of type S₂, and N₃^{all} servers of type S₃. Of course, this initial cluster overprovisions for the expected workload, as all either of the N₁^{all} servers of type S₁, N₂^{all} servers of type S₂, and N₃^{all} servers of type S₃ may be used alone (in a homogeneous solution) to support the expected workload. The capacity planning tool may then progressively remove ones of the servers to arrive at an optimal heterogeneous solution that is capable of supporting the expected workload. For instance, ones of the servers of the various configuration types may be progressively removed in a round-robin fashion (e.g., remove a server of type S₁, then remove a server of type S₂, then remove a server of type S₃, etc.) until the heterogeneous solution is reached that is no longer able to support the expected workload as desired (where it is determined that the previous heterogeneous solution that was able to support the expected workload as desired is a possible solution). Each heterogeneous solution determined in the above manner may be evaluated in the manner described above. For instance, a WRR load balancing strategy may be determined for each heterogeneous solution and used to determine workload profiles for each server type, which in turn are used to determine a Demand for each server type to determine if the heterogeneous cluster has sufficient capacity for supporting the expected workload in accordance with the specified service parameters 104.

Again, as mentioned above, various other techniques for selecting heterogeneous clusters to be evaluated may be utilized in accordance with embodiments of the capacity planning tool described herein, including without limitation a user (e.g., service provider) inputting one or more specific heterogeneous clusters (e.g., specific combinations of nodes of different types) to be evaluated, and a user (e.g., service provider) inputting identification of an existing cluster of nodes and one or more configuration types of nodes to be evaluated for adding to the existing cluster for improving the capacity of such existing cluster so as to support the expected workload in a desired manner.

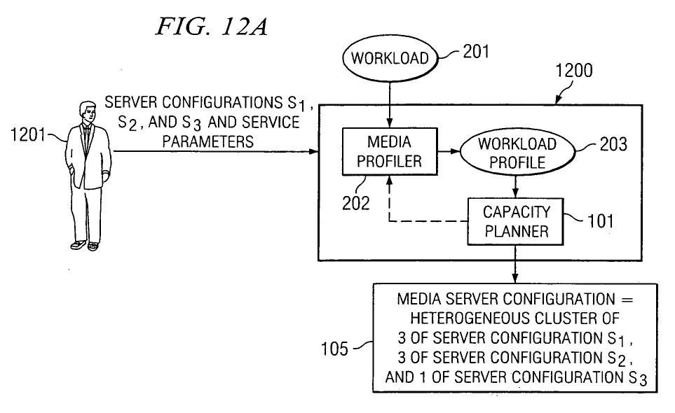

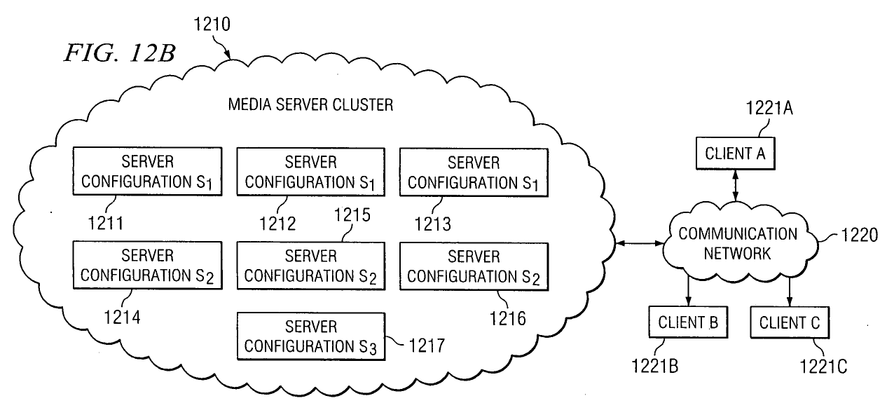

FIG. 12A shows an example of one embodiment of a capacity planning system 1200, wherein a user (e.g., a service provider) 1201 inputs information specifying server configurations to be considered (i.e., server configurations S₁, S₂, and S₃ in this example), and service parameters 104. As described above, the service provider may input a number of each server configuration that is available or a specific combination of the specified server configurations to evaluate. Of course, as also mentioned above, in some embodiments, the service provider may simply identify those server configurations to be included in the evaluation, and capacity planner 101 determines various homogeneous and heterogeneous solutions that may be formed with such server configurations. As described with the example embodiments above, workload information 201 is also supplied to MediaProf 202, which generates workload profile(s) 203. Capacity planner 101 uses the workload profile(s) 203 to determine the number of nodes of each configuration type to be included in a cluster for supporting the expected workload in the desired manner. As described above, capacity planner 101 may use an iterative technique for computing a service demand for the configurations under consideration and verifying the number of nodes indicated by such service demand. In this example, capacity planner 101 outputs solution information 105 indicating that the media server configuration solution is a cluster of 3 nodes of server configurations S₁, 3 nodes of server configurations S₂, and 1 node of server configuration S₃. Of course, a plurality of such possible solutions may be output by capacity planner 101.

Accordingly, in the example of FIG. 12A, capacity planner 101 indicates that the media server configuration solution for service provider 1201 is a cluster of 3 nodes of server configurations S₁, 3 nodes of server configurations S₂, and 1 node of server configuration S₃. As also mentioned above, the output may further identify the proper weighting to be assigned to each node of the cluster in a weighted load balancing strategy, such as WRR, to be used for the cluster. FIG. 12B shows an example of a media server cluster 1210 that service provider 1201 may implement in accordance with the solution provided by the capacity planning system 1200. Accordingly, media server cluster 1210 has 7 nodes (1211-1217), where 3 of such nodes (1211-1213) are of type S₁, 3 of such nodes (1214-1216) are of type S₂, and 1 node (1217) is of type S₃, as specified by output 105 of capacity planning system 1200 in FIG. 12A. Such media server cluster 1210 may be employed by service provider 1201 for serving streaming media files to clients, such as client A 1221A, client B 1221B, and client C 1221C, via communication network 1220, which may be, for example, the Internet or other Wide Area Network (WAN), a local area network (LAN), a wireless network, any combination of the above, or any other communication network now known or later developed within the networking arts which permits two or more computers to communicate with each other.

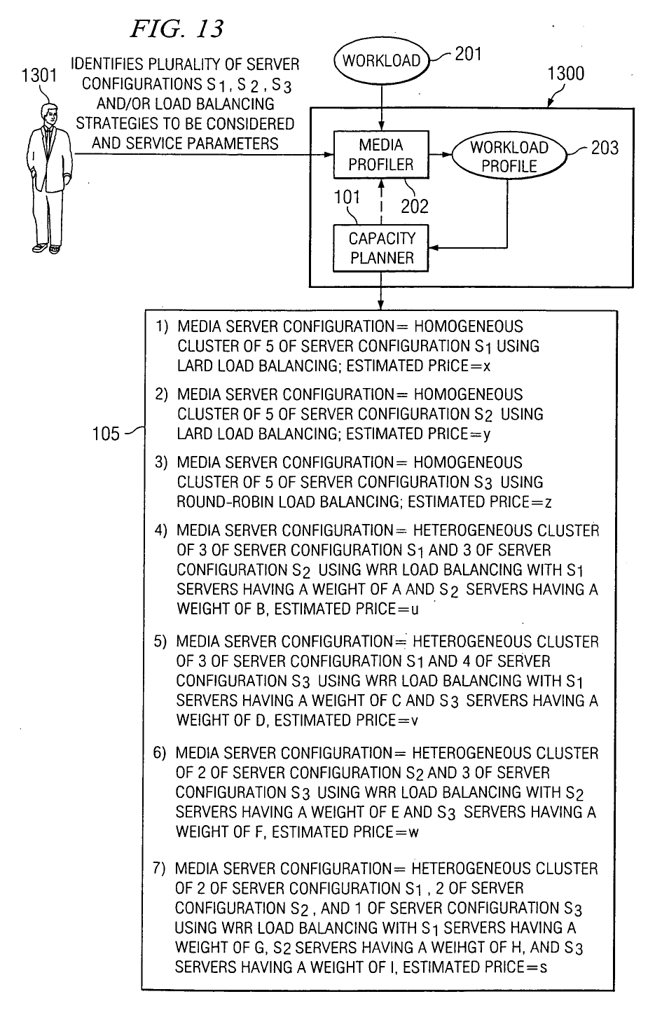

FIG. 13 shows another example embodiment of a capacity planning system 1300, wherein a user (e.g., a service provider) 1301 inputs information identifying a plurality of different server configurations S₁, S₂, S₃, and/or load balancing strategies to be evaluated, as well as specifying service parameters 104. For instance, the user may select ones of various different server configurations and/or load balancing strategies from a list presented by system 1300. Additionally or alternatively, the user may input sufficient information about each server configuration (e.g., its memory size, etc.) to enable capacity planning system 1300 to be capable of evaluating its capacity, and/or the user may input sufficient information detailing the type of load balancing employed for the type(s) of load balancing strategies desired to be considered (e.g., weighted round-robin, etc.). Accordingly, a user may either select configurations and load balancing strategies from the system 1300, or the user may supply sufficient information to define a type of configuration and/or load balancing strategy for the system 1300. In certain implementations, a pre-defined list of server configurations and load balancing strategies are evaluated by system 1300, and thus the user 1301 may not be required to input any information indicating those desired to be evaluated.

In certain situations, a service provider 1301 may want to evaluate a plurality of different homogeneous and heterogeneous media server solutions (e.g., to determine one of those solutions that is most attractive to the service provider). As described with the example embodiments above, workload information 201 is also supplied to MediaProf 202, which generates workload profiles 203 for each of the different server configurations being considered in a media server solution. Capacity planner 101 uses the workload profiles 203 to determine the number of nodes of each type of server configuration being considered to be included in a cluster for supporting the expected workload in the desired manner. As described above, capacity planner 101 may use an iterative technique for computing a service demand for each configuration under consideration and verifying the number of nodes indicated by such service demand. In this example, capacity planner 101 outputs solution information 105 indicating that the following media server configuration solutions are available: 1) Media Server Config.=homogeneous cluster of 5 nodes of server configuration S₁ using LARD load balancing, with estimated price=$X; 2) Media Server Config.=homogeneous cluster of 5 nodes of server configuration S₂ using LARD load balancing, with estimated price=$Y; 3) Media Server Config.=homogeneous cluster of 7 nodes of server configuration S₃ using round-robin load balancing, with estimated price=$Z; 4) Media Server Config.=heterogeneous cluster of 3 nodes of server configuration S₁ and 3 nodes of server configuration S₂ using WRR load balancing with S₁ servers having a weight of “A” and S₂ servers having a weight of “B”, with estimated price=$U . . . . Thus, the service provider 1301 may compare the various solutions, including their relative prices, and select a solution that is considered most attractive, and the service provider 1301 has knowledge that such solution is capable of supporting the service provider's expected workload in a desired manner.

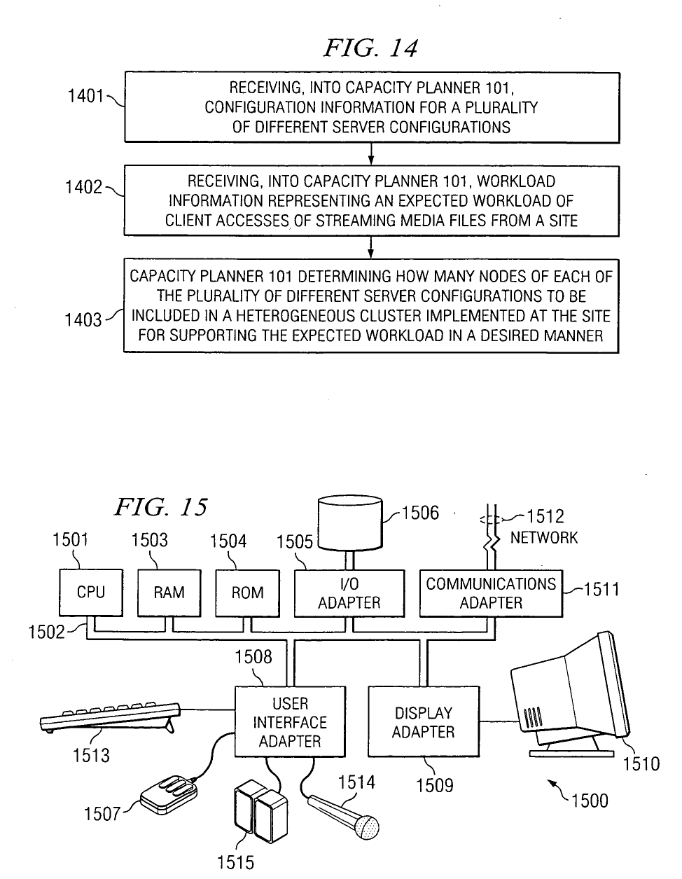

FIG. 14 shows an operational flow diagram of one embodiment for using a capacity planning tool, such as the example capacity planning systems described above. As shown, operational block 1401 receives configuration information for a plurality of different server configurations, such as S₁, S₂, and S₃, into a capacity planning tool. As examples, capacity planner 101 may have such configuration information input by a user (e.g., a service provider), or capacity planner 101 may read such configuration information from a data storage device (e.g., RAM, hard disk, etc.) of the capacity planning system (e.g., the configuration information may be pre-stored to the capacity planning system). Operational block 1402 receives into the capacity planning tool workload information representing an expected workload of client accesses of streaming media files from a site. In operational block 1403, capacity planner 101 determines how many nodes of each of the plurality of different server configurations to be included in a heterogeneous cluster implemented at the site for supporting the expected workload in a desired manner (e.g., in compliance with service parameters 104).

When implemented via computer-executable instructions, various elements of embodiments described herein for evaluating server configuration(s)' capacity for supporting an expected workload are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

FIG. 15 illustrates an example computer system 1500 adapted according to an embodiment for evaluating server configuration(s') capacity for supporting an expected workload. That is, computer system 1500 comprises an example system on which embodiments described herein may be implemented. Central processing unit (CPU) 1501 is coupled to system bus 1502. CPU 1501 may be any general purpose CPU. The above-described embodiments of a capacity planning system are not restricted by the architecture of CPU 1501 as long as CPU 1501 supports the inventive operations as described herein. CPU 1501 may execute the various logical instructions according to embodiments described herein. For example, CPU 1501 may execute machine-level instructions according to the exemplary operational flows described above in conjunction with FIGS. 8, 9, 10, 11, and 14.

Computer system 1500 also preferably includes random access memory (RAM) 1503, which may be SRAM, DRAM, SDRAM, or the like. Computer system 1500 preferably includes read-only memory (ROM) 1504 which may be PROM, EPROM, EEPROM, or the like. RAM 1503 and ROM 1504 hold user and system data and programs, as is well known in the art.

Computer system 1500 also preferably includes input/output (I/O) adapter 1505, communications adapter 1511, user interface adapter 1408, and display adapter 1509. I/O adapter 1505, user interface adapter 1508, and/or communications adapter 1511 may, in certain embodiments, enable a user to interact with computer system 1500 in order to input information thereto.

I/O adapter 1505 preferably connects storage device(s) 1506, such as one or more of hard drive, compact disc (CD) drive, floppy disk drive, tape drive, etc. to computer system 1500. The storage devices may be utilized when RAM 1503 is insufficient for the memory requirements associated with storing data for application programs. RAM 1503, ROM 1504, and/or storage devices 1506 may be used for storing computer-executable code for evaluating the capacity of server configuration(s) in accordance with the embodiments described above. Communications adapter 1511 is preferably adapted to couple computer system 1500 to network 1512.

User interface adapter 1508 couples user input devices, such as keyboard 1513, pointing device 1507, and microphone 1514 and/or output devices, such as speaker(s) 1515 to computer system 1500. Display adapter 1509 is driven by CPU 1501 to control the display on display device 1510.

It shall be appreciated that the embodiments of a capacity planning system described herein are not limited to the architecture of system 1500. For example, any suitable processor-based device may be utilized, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments described above.

1. A method comprising:
receiving, into a capacity planning system, workload information representing an expected workload of client accesses of streaming media files from a site; and
said capacity planning system evaluating whether a heterogeneous cluster having a plurality of different server configurations included therein is capable of supporting the expected workload in a desired manner.

2. The method of claim 1 further comprising:
said capacity planning system determining a number of nodes of each of said plurality of different server configurations to be included in said heterogeneous cluster to provide sufficient capacity for supporting the expected workload in a desired manner.

3. The method of claim 1 wherein said workload information includes identification of a number of concurrent client accesses of said streaming media files from said site over a period of time.

4. The method of claim 3 wherein said workload information further includes identification of a corresponding encoding bit rate of each of said streaming media files accessed.

5. The method of claim 1 wherein said workload information comprises information from an access log collected over a period of time.

6. The method of claim 1 further comprising:
receiving, into said capacity planning system, configuration information for each of said plurality of different server configurations.

7. The method of claim 6 wherein said configuration information includes identification of size of memory of each of said plurality of different server configurations.

8. The method of claim 1 wherein said evaluating comprises:
computing a cost corresponding to resources of said heterogeneous cluster that are consumed in supporting the workload.

9. The method of claim 8 wherein said computing said cost comprises:
computing a cost for each of said plurality of different server configurations included in said heterogeneous cluster, where the computed cost for each server configuration corresponds to resources of nodes of such server configuration in the heterogeneous cluster that are consumed in supporting a portion of the expected workload that is allocated to said nodes.

10. The method of claim 8 wherein said computing said cost comprises:
computing a cost of consumed resources for a stream in said workload having a memory access to a streaming media file; and
computing a cost of consumed resources for a stream in said workload having a disk access to a streaming media file.

11. The method of claim 1 wherein said evaluating comprises:
computing a service demand for each of said plurality of different server configurations in supporting said expected workload.

12. The method of claim 11 wherein said computing said service demand comprises computing:
$$Demand = {\sum }_{i = 1}^{{K}_{W}} {N}_{{X}_{{W}_{i}}}^{memory} \times {cost}_{{X}_{{W}_{i}}}^{memory} + {\sum }_{i = 1}^{{K}_{W}} {N}_{{X}_{{W}_{i}}}^{disk} \times {cost}_{{X}_{{W}_{i}}}^{disk} ,$$
wherein the workload W comprises X_{w}=X₁, . . . , Xₖ set of different encoded bit rates of files served in the workload,
$${N}_{{X}_{{w}_{i}}}^{memory}$$
is a number of streams in the workload having a memory access to a subset of files encoded at X_{W}_{ᵢ} Kb/s,
$${cost}_{{X}_{{W}_{i}}}^{memory}$$
is a cost of consumed resources for a stream having a memory access to a file encoded at X_{w}_{ᵢ} Kb/s,
$${N}_{{X}_{{w}_{i}}}^{disk}$$
is a number of streams in the workload having a disk access to a subset of files encoded at X_{W}_{ᵢ} Kb/s, and
$${cost}_{{X}_{{W}_{i}}}^{disk}$$
is a cost of consumed resources for a stream having a disk access to a file encoded at X_{w}_{ᵢ} Kb/s.

13. The method of claim 12 further comprising:
said capacity planning system determining from said computed service demand how many nodes of each of said plurality of different server configurations to be included in said heterogeneous cluster for supporting the expected workload in the desired manner.

14. The method of claim 1 further comprising:
receiving at least one service parameter.

15. The method of claim 14 wherein said at least one service parameter comprises information identifying at least one performance criteria desired to be satisfied by said site in supporting the expected workload in the desired manner.

16. The method of claim 15 wherein said at least one performance criteria specifies a minimum percentage of time that said site is desired to be capable of supporting the workload.

17. The method of claim 14 wherein said at least one service parameter comprises information identifying a constraint.

18. The method of claim 14 wherein said evaluating comprises:
evaluating whether said heterogeneous cluster is capable of supporting the expected workload in a manner that satisfies said at least one service parameter.

19. The method of claim 1 wherein said plurality of different server configurations have different memory sizes.

20. The method of claim 1 said evaluating further comprises:
said capacity planning system determining, for each server included in the determined at least one heterogeneous cluster, a weight to be assigned such server for use by a weighted load balancing technique for optimally balancing distribution of the expected workload within the heterogeneous cluster.

21. A method comprising:
receiving, into a capacity planning system, workload information representing an expected workload of client accesses of streaming media files from a site;
said capacity planning system receiving identification of a plurality of different server configurations to consider in determining a media server solution that is capable of supporting the expected workload in a desired manner; and
said capacity planning system determining at least one clustered media server solution that is capable of supporting the expected workload in the desired manner, wherein in determining the at least one clustered media server solution, the capacity planning system is operable to evaluate at least one heterogeneous cluster having a mix of said plurality of different server configurations.

22. The method of claim 21 wherein said determining at least one clustered media server solution comprises:
determining at least one heterogeneous clustered media server solution.

23. The method of claim 21 wherein said determining at least one clustered media server solution comprises:
determining a plurality of different clustered media server solutions that are each capable of supporting the expected workload in the desired manner.

24. The method of claim 23 wherein said plurality of different clustered media server solutions comprises at least one homogeneous clustered media server solution.

25. The method of claim 23 wherein the plurality of different clustered media server solutions comprises at least one heterogeneous clustered media server solution.

26. The method of claim 21 further comprising:
receiving at least one service parameter.

27. The method of claim 26 wherein said determining at least one clustered media server solution that is capable of supporting the expected workload in the desired manner comprises:
determining said at least one clustered media server solution that is capable of supporting the expected workload in a manner that satisfies said at least one service parameter.

28. The method of claim 21 wherein said plurality of different server configurations have different memory sizes.

29. The method of claim 21 further comprising:
said capacity planning system determining, for each server included in the determined at least one clustered media server solution, a weight to be assigned such server for use by a weighted load balancing technique for optimally balancing distribution of the expected workload within the clustered media server solution.

30. A method comprising:
receiving, into a capacity planning system, workload information representing an expected workload of client accesses of streaming media files from a site;
said capacity planning system determining at least one heterogeneous cluster to evaluate; and
said capacity planning system evaluating whether said determined at least one heterogeneous cluster is capable of supporting the expected workload in a desired manner.

31. The method of claim 30 wherein said determining at least one heterogeneous cluster to evaluate comprises:
said capacity planning system receiving input specifying said at least one heterogeneous cluster to evaluate.

32. The method of claim 31 wherein said input specifying said at least one heterogeneous cluster to evaluate specifies a number of nodes of each of a plurality of different types of server configurations included in the heterogeneous cluster to evaluate.

33. The method of claim 30 wherein said determining at least one heterogeneous cluster to evaluate comprises:
the capacity planning system receiving input specifying a finite number of each of a plurality of different types of servers that are available for use in forming a heterogeneous cluster; and
the capacity planning tool determining at least one combination of said available servers to form said heterogeneous cluster to evaluate.

34. The method of claim 33 wherein the capacity planning tool determines a plurality of different combinations of said available servers to form a plurality of different heterogeneous clusters to evaluate.

35. The method of claim 30 wherein said determining at least one heterogeneous cluster to evaluate comprises:
the capacity planning system receiving input specifying, for each of a plurality of different server configuration types, a finite number of nodes of such server configuration type; and
the capacity planning tool determining at least one combination of said nodes to form said heterogeneous cluster to evaluate.

36. The method of claim 30 wherein said determining at least one heterogeneous cluster to evaluate comprises:
the capacity planning system receiving input identifying a plurality of different server configuration types to consider; and
the capacity planning system determining, for each of the plurality of different server configuration types, the number of nodes of such server configuration type required for forming a homogeneous solution for supporting the expected workload in the desired manner.

37. The method of claim 36 wherein said determining at least one heterogeneous cluster to evaluate further comprises:
determining a first heterogeneous cluster to evaluate as a cluster having the determined number of nodes of their respective homogeneous solution of each of the plurality of different server configuration types.

38. The method of claim 37 wherein said determining at least one heterogeneous cluster to evaluate further comprises:
determining a second heterogeneous cluster by removing at least one node from the determined first heterogeneous cluster.

39. The method of claim 30 wherein said determining at least one heterogeneous cluster to evaluate comprises:
the capacity planning system receiving input specifying an existing cluster of nodes of at least a first configuration type; and
the capacity planning system receiving input identifying at least a second configuration type to be considered for inclusion with the existing cluster of nodes.

40. The method of claim 30 further comprising:
said capacity planning system determining a number of nodes of each of a plurality of different server configurations to be included in a heterogeneous cluster to provide sufficient capacity for supporting the expected workload in the desired manner.

41. The method of claim 30 further comprising:
receiving, into said capacity planning system, configuration information for each of a plurality of different server configurations included in the heterogeneous cluster.

42. The method of claim 41 wherein said configuration information includes identification of size of memory of each of said plurality of different server configurations.

43. The method of claim 30 further comprising:
receiving at least one service parameter.

44. The method of claim 41 wherein said evaluating comprises:
evaluating whether said heterogeneous cluster is capable of supporting the expected workload in a manner that satisfies said at least one service parameter.

45. The method of claim 30 wherein said heterogeneous cluster includes nodes of a plurality of different server configuration types that have different memory sizes.

46. The method of claim 30 wherein said evaluating further comprises:
said capacity planning system determining, for each server included in the determined at least one heterogeneous cluster, a weight to be assigned such server for use by a weighted load balancing technique for optimally balancing distribution of the expected workload within the determined at least one heterogeneous cluster.

47. A method comprising:
receiving, into a capacity planning system, workload information representing an expected workload of client accesses of streaming media files from a site; and
said capacity planning system determining a heterogeneous clustered media server solution that is capable of supporting the expected workload in a desired manner, wherein said planning system determines, for each of a plurality of different server configurations included in the heterogeneous clustered media server solution, how many servers to include in the heterogeneous clustered media server solution.

48. The method of claim 47 further comprising:
receiving at least one service parameter.

49. The method of claim 48 wherein said determining comprises:
determining said heterogeneous clustered media server solution that is capable of supporting the expected workload in a manner that satisfies said at least one service parameter.

50. The method of claim 47 wherein said plurality of different server configurations included in the heterogeneous clustered media server solution have different memory sizes.

51. The method of claim 47 further comprising:
said capacity planning system determining, for each server included in the determined heterogeneous clustered media server solution, a weight to be assigned such server for use by a weighted load balancing technique for optimally balancing distribution of the expected workload within the heterogeneous clustered media server solution.

52. A method comprising:
a capacity planning system determining at least one heterogeneous cluster to evaluate; and
said capacity planning system determining, for each server included in the determined at least one heterogeneous cluster, a weight to be assigned such server for use by a weighted load balancing technique for optimally balancing distribution of a received workload within the determined at least one heterogeneous cluster.

53. The method of claim 52 wherein said weighted load balancing technique is a weighted round-robin technique.

54. The method of claim 52 wherein said determining said weight to be assigned to each server in the determined at least one heterogeneous cluster comprises:
determining, for each of a plurality of different server configuration types included in the heterogeneous cluster, a number of nodes of such server configuration type required to support an expected workload in a desired manner.

55. The method of claim 54 wherein said determining said weight to be assigned to each server in the determined at least one heterogeneous cluster further comprises:
based at least in part on the determined number of nodes of each server configuration type required to support an expected workload in a desired manner, determining a relative capacity of each server configuration type.

56. The method of claim 55 wherein said determining said weight to be assigned to each server in the determined at least one heterogeneous cluster further comprises:
using the determined relative capacity of each server configuration type to determine said weight.

57. The method of claim 55 wherein said determining said weight to be assigned to each server in the determined at least one heterogeneous cluster further comprises:
determining said weight of each server based on the corresponding determined relative capacity of each server configuration type.

58. The method of claim 52 further comprising:
receiving, into said capacity planning system, workload information representing an expected workload of client accesses of streaming media files from a site; and
said capacity planning system evaluating whether said determined at least one heterogeneous cluster employing a weighted load balancing technique with the determined weights is capable of supporting the expected workload in a desired manner.

59. A method comprising:
receiving, into a capacity planning system, workload information representing an expected workload of client accesses of streaming media files from a site;
receiving, into said capacity planning system, at least one service parameter;
said capacity planning system determining at least one heterogeneous cluster to evaluate;
for a first heterogeneous cluster to evaluate, said capacity planning system determining a portion of said expected workload to be dispatched to each type of server included in the first heterogeneous cluster;
said capacity planning system computing a service demand for each type of server in the first heterogeneous cluster under its respective portion of the expected workload;
said capacity planning system determining from the computed service demands whether the first heterogeneous cluster has sufficient capacity for supporting the expected workload in accordance with the at least one service parameter; and
said capacity planning system outputting information indicating whether the first heterogeneous cluster is determined to have sufficient capacity for supporting the expected workload in accordance with the at least one service parameter.

60. A method comprising:
receiving, into a capacity planning system, workload information representing an expected workload of client accesses of streaming media files from a site;
receiving, into said capacity planning system, at least one service parameter;
said capacity planning system determining a plurality of different server configuration types to be included in a heterogeneous cluster for servicing the expected workload;
for the heterogeneous cluster, said capacity planning system determining a portion of said expected workload to be dispatched to each type of server included therein;
said capacity planning system computing a service demand for each type of server in the heterogeneous cluster under its respective portion of the expected workload;
said capacity planning system determining from the computed service demands a number of nodes of each type of server to be included in the heterogeneous cluster to have sufficient capacity for supporting the expected workload in accordance with the at least one service parameter; and
said capacity planning system outputting information indicating the determined number of nodes.

61. A system comprising:
means for receiving workload information representing an expected workload of client accesses of streaming media files from a site; and
means for evaluating whether a heterogeneous cluster that includes a plurality of different types of server configurations therein provides sufficient capacity for supporting the expected workload in a desired manner.

62. The system of claim 61 wherein the plurality of different types of server configurations have different memory sizes.

63. A system comprising:
a media profiler operable to receive workload information for a service provider's site and generate a workload profile for each of a plurality of different types of server configurations included in a heterogeneous cluster under consideration for supporting the service provider's site; and
a capacity planner operable to receive the generated workload profiles for the server configurations of the heterogeneous cluster under consideration and evaluate whether the heterogeneous cluster provides sufficient capacity for supporting the site's workload.

64. The system of claim 63 wherein in evaluating whether the heterogeneous cluster provides sufficient capacity for supporting the site's workload, said capacity planner evaluates whether the heterogeneous cluster provides sufficient capacity for supporting the site's workload in accordance with at least one service parameter.

65. The system of claim 63 wherein said workload profile comprises:
for a plurality of different points in time, identification of a number of concurrent client accesses, wherein the number of concurrent client accesses are categorized into corresponding encoding bit rates of streaming media files accessed thereby and are further sub-categorized into either memory or disk accesses.

66. The system of claim 63 further comprising:
a dispatcher operable to receive a client access log collected over a period of time for said service provider's site and generate said workload information received by said media profiler.

67. The system of claim 66 wherein said dispatcher is operable to receive identification of servers included in the heterogeneous cluster under consideration and determine for each of said number of servers the client accesses of the client access log that are assigned to such server under a load balancing strategy.

68. The system of claim 67 wherein the load balancing strategy is a weighted load balancing strategy, and wherein the capacity planner determines, for each server in the heterogeneous cluster under consideration, a weight to be assigned to such server.

69. The system of claim 68 wherein the weighted load balancing strategy is a weighted round-robin strategy.

70. Computer-executable software code stored to a computer-readable medium, the computer-executable software code comprising:
code for receiving workload information representing an expected workload of client accesses of streaming media files from a site; and
code for evaluating a heterogeneous clustered media server that includes a plurality of different types of server configurations therein to determine whether the heterogeneous clustered media server under evaluation provides sufficient capacity for supporting the expected workload in a desired manner.

71. The computer-executable software code of claim 70 further comprising:
code for determining how many nodes of each of said plurality of different configuration types to be implemented in a heterogeneous cluster at said site for supporting the expected workload in the desired manner.

72. Computer-executable software code of claim 71 wherein said code for determining how many nodes of each of said plurality of different configuration types to be implemented as a heterogeneous cluster at said site for supporting the expected workload in the desired manner comprises:
code for determining how many nodes of each of said plurality of different configuration types to be implemented as a heterogeneous cluster such that the heterogeneous cluster is capable of supporting said expected workload in accordance with at least one service parameter.
